(19) United States
(12) Patent Application Publication
(10) Pub. No.: US 2007/0182894 A1
(43) Pub. Date: Aug. 9, 2007

(54) Optical compensatory element, manufacturing method thereof, liquid crystal display and liquid crystal projector

(75) Inventors: Kenichi Nakagawa, Shizuoka (JP); Masao Sato, Shizuoka (JP); Yosuke Takeuchi, Shizuoka (JP); Shintaro Washizu, Tokyo (JP)

Correspondence Address: BUCHANAN, INGERSOLL & ROONEY PC, POST OFFICE BOX 1404, ALEXANDRIA, VA, 22313-1404, US

(73) Assignee: FUJI PHOTO FILM CO., LTD., Minami-Ashigara-shi, Kanagawa (JP)

(21) Appl. No.: 10/590,756

(22) PCT Filed: Mar. 7, 2005
(86) PCT No.: PCT/JP05/04377

§ 371 Date: Feb. 28, 2007

(30) Foreign Application Priority Data
Mar. 11, 2004 (JP) 2004-069839
Dec. 21, 2004 (JP) 2004-370249

(51) Int. Cl. G02F 1/1335

(52) U.S. Cl. 349/117

(57) ABSTRACT

To provide an optical compensatory element that can optically compensate a liquid crystal layer under a condition for displaying black more precisely and prevent light leakage at a wide viewing angle, and to provide a liquid crystal display and a liquid crystal projector using the optical compensatory element, an optical compensatory element includes a support, at least one first optically anisotropic layer derived from at least one of inorganic materials and arranged on or above at least one side of the support, and a second optically anisotropic layer derived from at least one of polymerizable liquid crystal compounds and being arranged on or above at least one side of the support.

### TECHNICAL FIELD

The present invention relates to an optical compensatory element and a method for manufacturing the optical compensatory element. It also relates to a liquid crystal display and a liquid crystal projector using the optical compensatory element.

### BACKGROUND ART

Liquid crystal displays (LCDs) have been increasingly developed and used typically in mobile phones, monitors for personal computers, television sets and liquid crystal projectors.

In such liquid crystal displays, liquid crystals electrically control light passing through the liquid crystal to show light and dark gradation on a screen to thereby display characters and/or images.

Examples of the mode for operating the liquid crystal are a twisted nematic (TN) mode, a vertical alignment (VA) mode, an in-plane switching (IPS) mode, an optically compensatory bend (OCB) mode, and an electrically controlled birefringence (ECB) mode.

TFT (thin film transistor)-LCDs are often used as the liquid crystal displays and are often operated in the TN mode for operating the liquid crystal. Liquid crystal displays for use in a variety of applications require a high contrast, and liquid crystal displays of the VA mode have been increasingly developed.

A liquid crystal display of the TN mode comprises two glass substrates, a nematic liquid crystal twisted by 90 degrees and encapsulated in between the two glass substrates, and a pair of polarizing plates arranged so as to sandwich the two glass substrates in a cross nicol manner. When no voltage is applied, linearly polarized light passes through the polarizing plate as a polarizer, the plane of polarization of the light is then twisted by 90 degrees in the liquid crystal layer, and the light passes through the polarizing plate as an analyzer to display white. Upon application of a sufficient voltage, the direction of alignment of the liquid crystal becomes substantially perpendicular to the liquid crystal panel, linearly polarized light passing through the polarizing plate near to the polarizer passes through the liquid crystal layer without changing its optical polarization and reaches the polarizing plate near to the analyzer to thereby display black.

A liquid crystal display of the VA mode comprises two glass substrates, a nematic liquid crystal encapsulated in between the two glass substrates so as to be aligned vertically or vertically/obliquely, and a pair of polarizing plates arranged so as to sandwich the two glass substrates in a cross nicol manner. When no voltage is applied, linearly polarized light passes through the polarizing plate as a polarizer, passes through the liquid crystal layer without substantially changing its plane of polarization and reaches a polarizing plate as an analyzer so as to display black. Upon application of a sufficient voltage, the direction of alignment of the liquid crystal changes to being in parallel with the liquid crystal panel and twisted by 90 degrees, linearly polarized light passes through the polarizing plate near to the polarizer, the plane of polarization of the light is twisted by 90 degrees in the liquid crystal layer, and the light passes through the polarizing plate near to the analyzer so as to display white.

Such liquid crystal displays operated according to these display modes show viewing angle dependency, in which display properties are deteriorated when the display screen is viewed from an oblique direction. For example, the contrast is decreased and/or tone reversal occurs in gray level display.

The viewing angle dependency is caused by light leakage in which the display of the liquid crystal display may not become completely black at some viewing angles.

Accordingly, optical compensatory films for avoiding the viewing angle dependency have been proposed. According to this technique, the phase difference of light passing through a liquid crystal layer under a condition for displaying black and the phase difference of an optically anisotropic layer are combined so as to optically compensate the liquid crystal layer under a condition for displaying black three-dimensionally to thereby avoid light leakage at every angle.

The present applicant, for example, have proposed an optical compensatory sheet as the optical compensatory film in Japanese Patent Application Laid-Open (JP-A) No. 08-50206. The optical compensatory sheet comprises a support, such as a cellulose triacetate (TAC) film, and an optically anisotropic layer arranged on or above the support, in which the optically anisotropic layer comprises a compound containing a discotic structural unit and having an optical anisotropy, the disc plane of the discotic structural unit is oblique to the plane of the support, the optically anisotropic layer is in a hybrid alignment where an angle formed between the disc plane of the discotic structural unit and the plane of the support varies in a thickness direction of the optically anisotropic layer, and the support has properties of an ellipsoid having an optically substantially uniaxial negative reflective index.

In the optical compensatory film, the discotic structural unit of the optically anisotropic layer is arrayed perpendicularly with the liquid crystal layer under a condition for displaying black. Thus, the liquid crystal layer under a condition for displaying black is optically compensated in optical properties of the entire multilayered structure comprising the support and the discotic structural unit. The light leakage can be prevented at a wide range of viewing angles.

This technique successfully reduces the viewing angle dependency of liquid crystal displays and enlarges the viewing angle by using the optical compensatory film. However, a further wider viewing angle and a higher contrast are required in large-screen liquid crystal monitors and liquid crystal projectors to display in a large screen. Among them, liquid crystal projectors require a higher contrast, because light entering a liquid crystal cell at various incident angles is combined by the action of a projection lens and is enlarged and projected onto a screen therein. The optical compensatory film must be further improved when used in these applications.

More specifically, the optical compensatory film uses a TAC film as the support, the thickness of the TAC film cannot be highly uniformized, and desired optical properties of the TAC film cannot be significantly obtained precisely. Accordingly, the optical compensatory film is insufficient to optically compensate a liquid crystal layer under a condition for displaying highly precise black and to prevent light leakage at a wide viewing angle so as to meet the demands in recent years.

As another possible solution, International Publication No. W001/090808, for example, discloses a contrast ratio improving method for a liquid crystal projector. In the method, the liquid crystal projector comprises an optical film having a liquid crystal layer with hybrid alignment as a liquid crystal cell, and two polarizing plates sandwiching the optical film, in which the optical film comprises a base film comprising a plastic film showing substantially no birefringence, and the liquid crystal layer with hybrid alignment on or above the base film.

Even this technique, however is insufficient to optically compensate liquid crystal layer under a condition for displaying highly precise black and to prevent light leakage at a wide viewing angle.

### DISCLOSURE OF INVENTION

Accordingly, an object of the present invention is to provide an optical compensatory element which can optically compensate a liquid crystal layer under a condition for displaying black further highly precisely and prevent light leakage at a wide viewing angle and to provide a method for manufacturing the optical compensatory element. Another object of the present invention is to provide a liquid crystal display and a liquid crystal projector that can produce a high-quality image at a wide viewing angle and a high contrast.

Specifically, the present invention provides an optical compensatory element including a support, at least one first optically anisotropic layer derived from at least one of inorganic materials and arranged on or above at least one side of the support, and at least one second optically anisotropic layer derived from at least one of polymerizable liquid crystal compounds and arranged on or above at least one side of the support. The optical compensatory element can optically compensate a liquid crystal layer under a condition for displaying black more precisely and prevent light leakage at a wide viewing angle.

The present invention also provide a method for manufacturing an optical compensatory element, including the processes of laminating plural layers in a regular order on or above a support, the plural layers each containing one or more inorganic materials and having different refractive indices, and polymerizing a polymerizable liquid crystal compound having a liquid crystal structure while keeping the liquid crystal structure being aligned. The method does not fundamentally depend on the order of lamination of layers and can manufacture an optical compensatory element capable of optically compensating a liquid crystal layer under a condition for displaying black more precisely and preventing light leakage by carrying out the processes to laminate the layers.

The present invention further provides a liquid crystal display, including a liquid crystal device containing at least one pair of electrodes and liquid crystal molecules encapsulated in between the at least one pair of electrodes, an optical compensatory element arranged on or above at least one side of the liquid crystal device, and

at least one polarizing element facing the liquid crystal device and the optical compensatory element, in which the optical compensatory element is the optical compensatory element according to the present invention. The liquid crystal display can display a high-contrast image at a wide viewing angle.

In addition and advantageously, the present invention provides a liquid crystal projector including a liquid crystal display, a light source for applying light to the liquid crystal display, and a projection optical system for forming an image on a screen from light optically modulated by the liquid crystal display, in which the liquid crystal display is the liquid crystal display of the present invention. The liquid crystal projector can project a high-contrast image.

### BRIEF DESCRIPTION OF THE DRAWINGS

FIG. 1 is a sectional view showing an example of the optical compensatory element according to a first configuration of the present invention;

FIG. 2 is a sectional view showing an example of the optical compensatory element according to a second configuration of the present invention;

FIG. 3 is a sectional view showing an example of the optical compensatory element according to a third configuration of the present invention;

FIG. 4 is a sectional view showing an example of the optical compensatory element according to a fourth configuration of the present invention;

FIG. 5 is a sectional view showing an example of the optical compensatory element according to a fifth configuration of the present invention;

FIG. 6 is a sectional view showing an example of the optical compensatory element according to a sixth configuration of the present invention;

FIG. 7 is a sectional view showing an example of the optical compensatory element according to a seventh configuration of the present invention;

FIG. 8 is a sectional view showing an example of the optical compensatory element according to an eighth configuration of the present invention;

FIG. 9 is a sectional view of an example of the liquid crystal display of the present invention;

FIG. 10 is a sectional view of an example of the liquid crystal display of the present invention;

FIG. 11 is a sectional view of an example of the liquid crystal display of the present invention;

FIG. 12 is a sectional view of an example of .the liquid crystal display of the present invention;

FIG. 13 is an outside view showing an example of a rear-projection liquid crystal projector according to the present invention; and

FIG. 14 is a schematic diagram showing an example of a projection unit of the liquid crystal projector of the present invention.

### BEST MODE FOR CARRYING OUT THE INVENTION

(Optical Compensatory Element)

The optical compensatory element of the present invention comprises a support, at least one first optically anisotropic layer derived from at least one of inorganic materials and arranged on or above the support, and at least one second optically anisotropic layer derived from at least one of polymerizable liquid crystal compounds and being arranged on or above the support. The optical compensatory element may further comprise any other layers or components according to necessity.

—Support—

The support is not specifically limited, can be appropriately selected according to the purpose and includes, for example, white sheet glass, blue sheet glass, quartz glass, alkali-free glass, sapphire glass and an organic polymer film.

The material for the organic polymer film is not specifically limited, can be appropriately selected according to the purpose and can be one or more of polymers selected from, for example, polyarylates, polyesters, polycarbonates, polyolefins, polyethers, polysulfines, polysulfones and poly(ether sulfone)s and cellulose esters. Suitable specific examples of the organic polymer film are polycarbonate copolymers, polyester copolymers, polyester/carbonate copolymers and polyarylate copolymers, of which polycarbonate copolymers are more preferred. Preferred examples of the polycarbonate copolymers are polycarbonate copolymers having a fluorene skeleton, of which polycarbonate copolymers prepared by reacting a bisphenol with phosgene or a compound capable of forming a carbonic ester, such as diphenyl carbonate, are typically preferred for their excellent optical transparency, thermostability and productivity. The content of the fluorene skeleton in the polycarbonate copolymer is preferably 1 to 99 percent by mole. A repeating unit disclosed in International Publication No. WO00/26705 can be used as the polycarbonate copolymer.

The material for the support is preferably glass derived from inorganic materials, for satisfactory smoothness of the plane of the support.

The thickness of the support is not specifically limited, can be appropriately set according to the purpose and is preferably, for example, 0.1 μm or more. The upper limit of the thickness is preferably 0.3 mm to 3 mm and more preferably 0.5 mm to 1.5 mm for easy handling in assembly and for sufficient mechanical strength.

—First Optically Anisotropic Layer—

The structure of the first optically anisotropic layer is not specifically limited and can be appropriately selected according to the purpose, as long as the layer as a whole exhibits optical anisotropy. The first optically anisotropic layer preferably has an alternately multilayered structure comprising a repeating unit, the repeating unit comprising plural layers having different refractive indices laminated in a regular order in a direction normal to the support, in which the repeating unit has an optical thickness, i.e., a thickness of a repeating unit in a laminating direction of the alternately multilayered structure (hereinafter referred to as “pitch of altanative structure”), less than the wavelengths of light in the visible region.

The respective repeating units may not always have the same thickness and may have different thickness typically depending on properties of light to pass through the first optically anisotropic layer.

The number of layers constituting one repeating unit is not specifically limited, can be appropriately set according to the purpose, as long as the layers are two or more layers having different refractive indices. The repeating unit preferably comprises two layers derived from two different inorganic materials, respectively.

The thickness of the respective layers constituting the alternately multilayered structure is not specifically limited, can be appropriately set according to the purpose, as long as it is less than the wavelength of light in the visible region, and is preferably λ/100 to λ/5, more preferably λ/50 to λ/5 and specifically preferably λ/30 to λ/10, wherein λ is the wavelength of light in the visible region.

The thickness of the respective layers constituting the alternately multilayered structure is preferably small so as to avoid optical interference among phases of the laminated layers. A small thickness, however, increases the number of film forming processes to obtain a required total thickness of the structure. An optimum thickness of the respective layers should be preferably determined according to the materials, refractive indices, thickness ratio and total thickness of the respective layers in consideration of desired optical properties of the first optically anisotropic layer and of avoiding phase interference between the respective layers.

The pitch of alternate structure is not specifically limited and can be selected from within the visible region according to the purpose, as long as it is shorter than light in the visible region. The “visible region” means a region of wavelengths of 400 nm to 700 nm, unless otherwise specified. Accordingly, the pitch of alternate structure is preferably set less than a range of 400 nm to 700 nm.

The retardation Rth of the first optically anisotropic layer as represented by following Equation (1) is preferably 20 nm to 500 nm and more preferably 20 nm to 400 nm.
Rth={(nₓ+n_{y})/2−n_{z}}×d Equation (1)

In Equation (1), nₓ, n_{y} and n_{z}, are refractive indices in the X, Y and Z axes in the first optically anisotropic layer, respectively, where the X, Y and Z axes are orthogonal to one another, provided that the direction of the normal to the support is defined as the Z axis; and “d” is the thickness of the first optically anisotropic layer.

The number of the repeated structure in the alternately multilayered structure is not specifically limited and can be appropriately selected according to the purpose.

The thickness of the first optically anisotropic layer preferably satisfies the retardation requirement and is more preferably 50 nm to 2000 nm and specifically preferably 100 nm to 1500 nm.

The material for the alternately multilayered structure constituting the first optically anisotropic layer is not specifically limited, can be appropriately selected according to the purpose and is preferably selected according to a desired difference in refractive index Δn, since the phase difference caused by birefringence of he first optically anisotropic layer is determined by the product between the thickness d of the first optically anisotropic layer and the difference in refractive index Δn of the respective layers constituting the repeated structure. More specifically, various vapor deposition materials such as TiO₂, ZrO₂, Nb₂O₅, MgO, CeO₂, SiO₂, SnO₂, Ta₃O₅, Y₂O₃, LiNbO₃, CaF₂, Al₂O₃ and MgF₂ can be used

The materials for the alternately multilayered structure are preferably selected from combinations of materials so that difference in refractive index Δn between the maximum and minimum refractive indices in the visible region is 0.5 or more. The alternately multilayered structure more preferably comprises oxide layers and specifically preferably comprises a combination of a SiO₂ layer having a refractive index n of 1.4870 to 1.5442 and a TiO₂ layer having a refractive index n of 2.583 to 2.741, or a combination of a SiO₂ layer having a refractive index n of 1.4870 to 1.5442 and a Nb₂O₅ layer having a refractive index n of 2.313.

If the difference in refractive index Δn is less than 0.5, the thickness d of the first optically anisotropic layer may be reduced so as to yield a desired phase difference in the first optically anisotropic layer to thereby increase the number of processes for laminating the repeating unit. Thus, the processability and productivity may be deteriorated.

The first optically anisotropic layer is equivalent to a medium having a uniform refractive index in a lamination direction of multiple layers, namely, in the direction of the normal to the support. The first optically anisotropic layer as a whole exhibits an anisotropy called as structural birefringence and has optical properties of a uniaxial ellipsoid having a negative refractive index and being not oblique. The first optically anisotropic layer has a high smoothness and can easily and precisely have desired properties such as the retardation by appropriately setting the materials thickness, number of layers and period of the pitch of alternate structure of the alternately multilayered structure.

The first optically anisotropic layer can have a function as an antireflective layer by appropriately setting the thickness of constitutional layers and thickness ratio thereof.

The retardation Rth can be determined by any appropriate method selected according to the purpose and includes, for example, by using an ellipsometer (M-150, available from JASCO Corporation).

—Second Optically Anisotropic Layer—

The second optically anisotropic layer comprises at least a polymerizable liquid crystal compound and may further comprise any other materials or configurations appropriately selected according to necessity.

The polymerizable liquid crystal compound is not specifically limited and can be appropriately selected according to the purpose. The liquid crystal structure of the polymerizable liquid crystal compound, for example, is preferably a liquid crystal structure whose alignment can be fixed, is more preferably a rod-shaped, discotic or banana-shaped liquid crystal structure and is specifically preferably a discotic liquid crystal structure.

The polymerizable liquid crystal compound may further comprise any other components appropriately selected according to necessity.

The term “liquid crystal structure is aligned (or in alignment)” used herein means that average directions of specific axes in a liquid crystal structure contained in a microdomain in question substantially agree with each other, when a specific axis of molecules constituting the liquid crystal derived from the molecular shape is set in a major axis direction in a rod-shaped molecule, and is set in the direction of the normal to a plane in a plane molecule. When the liquid crystal structure is aligned, the angle formed between the average direction of the liquid crystal structure of the microdomain in question and the lamination direction of the optical compensatory element (the normal direction at the interface between the second optically anisotropic layer and the support) is referred to as “angle of alignment”, and the projected component of the average direction of the specific axes projected onto the interface is referred to as “direction of alignment”.

As the alignment, the liquid crystal structure preferably has an oblique angle of alignment, namely, the angle of alignment is preferably not in parallel or perpendicular to a thickness direction of the second optically anisotropic layer. The liquid crystal structure is more preferably in a hybrid alignment in which the angle of alignment successively varies in the thickness direction between the upper surface and lower surface of the second optically anisotropic layer.

The angle of alignment in the hybrid alignment is preferably set so as to successively vary from 20°±20° to 65°±25° from the alignment layer toward the air interface.

The angle of alignment and direction of alignment of the polymerizable liquid crystal compound, which determine the alignment thereof, are preferably set so as to form mirror symmetry with the liquid crystal layer under a condition for displaying black.

The angles of alignment of the liquid crystal structure in the vicinity of the alignment layer, in the vicinity of the air interface, and the average angle of alignment in the second optically anisotropic layer are estimates determined by measuring retardations from multiple directions using an ellipsometer (M-150, available from JASCO Corporation), assuming a refractive index ellipsoid model from the measured retardations, and estimating the angles of alignment based on the refractive index ellipsoid model.

The angles of alignment can be determined from the retardations, for example, according to a procedure described in Design Concepts of Discotic Negative Birefringence Compensation Films SID98 DIGEST. The measurement directions of the retardation in determination of the angle of alignment are not specifically limited and can be appropriately set according to the purpose. For example, a retardation in the direction of the normal to the second optically anisotropic layer (Re0), a retardation in a direction at −40° to the normal direction (Re−40) and a retardation in a direction at +40° to the normal direction (Re+40).

The Re0, Re−40 and Re+40 are determined by changing the observation angle to the respective directions, using the ellipsometer.

The polymerizable liquid crystal compound having a rod-shaped liquid crystal structure is not specifically limited, can be appropriately selected according to the purpose and includes, for example, a polymerizable liquid crystal compound capable of fixing the alignment of the rod-shaped liquid crystal structure with the use of a polymer binder, and a polymerizable liquid crystal compound having a polymerizable group capable of the alignment of the liquid crystal structure as a result of polymerization. Among them, the polymerizable liquid crystal compound having the polymerizable group is preferred.

The rod-shaped liquid crystal structure is not specifically limited, can be appropriately selected according to the purpose and includes, for example, azomethines, azoxy compounds, cyanobiphenyl compounds, cyanophenyl esters, benzoic esters, cyclohexanecarboxylic acid phenyl esters, cyanophenylcyclohexanes, cyano-substituted phenylpyrimidines, alkoxy-substituted phenylpyrimidines, phenyldioxanes, tolanes and alkenylcyclohexylbenzonitriles.

Examples of the polymerizable liquid crystal compound having a rod-shaped liquid crystal structure are polymeric liquid crystal compounds formed by polymerization of a rod-shaped liquid crystal compound represented by following Structural Formula (1) and having low-molecular polymerizable groups.
Q¹-L¹-A¹-L³-M-L⁴-A²-L²-Q² Structural Formula (1)

In Structural Formula (1), Q¹ and Q² independently represent a polymerizable group; L¹, L², L³ and L⁴ independently represent a single bond or a divalent linkage group, wherein at least one of L² and L³ represents —O—CO—O; A¹ and A² independently represent a spacer group having two to twenty carbon atoms; and “M” represents a mesogenic group.

The polymerizable liquid crystal compound having a discotic liquid crystal structure is not specifically limited, can be appropriately selected according to the purpose and includes, for example, a polymerizable liquid crystal compound capable of fixing the alignment of the discotic liquid crystal structure by the use of a polymer binder, and a polymerizable liquid crystal compound having a polymerizable group capable of fixing the alignment of the discotic liquid crystal structure as a result of polymerization. Among them, the polymerizable liquid crystal compound having the polymerizable group is preferred.

The structure of the polymerizable liquid crystal compound having the polymerizable group includes, for example, a structure having one or more linkage groups introduced between a discotic core and the polymerizable group. Specific suitable examples of the polymerizable liquid crystal compound are compounds represented by following Structural Formula (2) as described in JP-A No. 08-050206.
D(−L−P)ₙ Structural Formula (2)

In Structural Formula (2), “D” represents a discotic core; “L” represents a divalent linkage group; “P” represents a polymerizable group; and “n” represents an integer of 4 to 12. Plural divalent linkage groups Ls and plural polymerizable groups Ps may be different from each other in combination, but these groups are preferably identical in their repetition. Two or more discotic cores Ds may be used herein.

Specific examples of the discotic core D in Structural Formula (2) are discotic cores represented by following Structural Formulae (D1) to (D15):

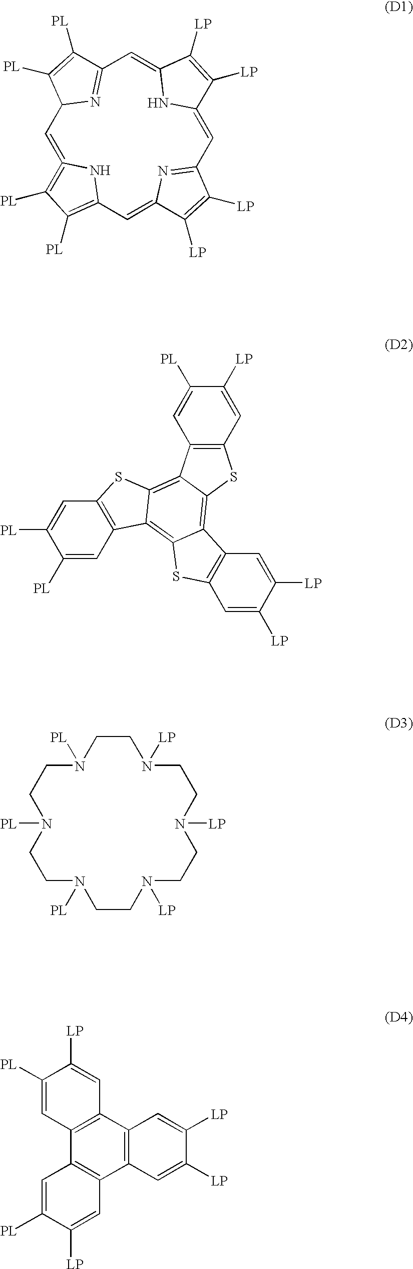

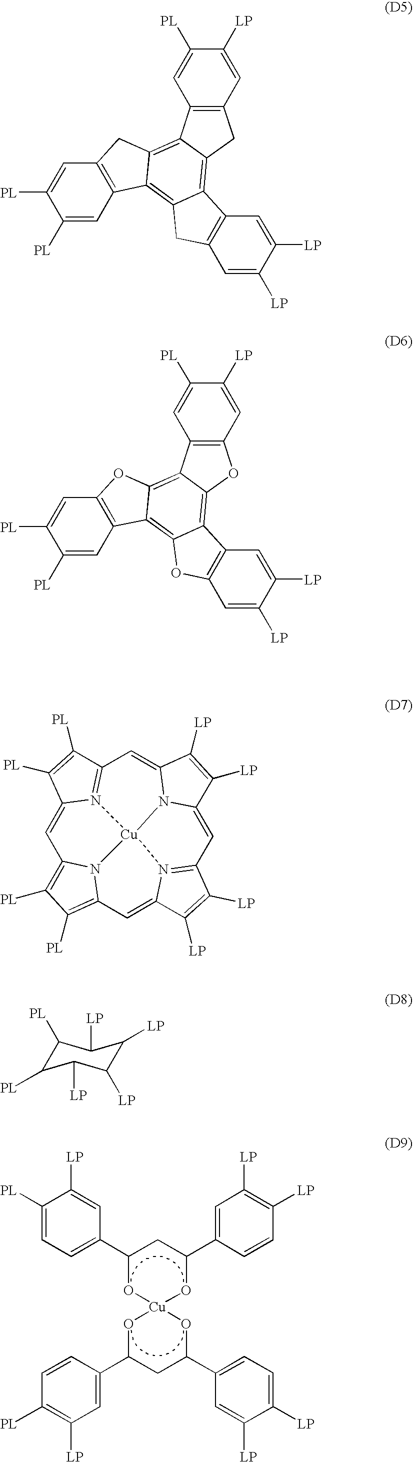

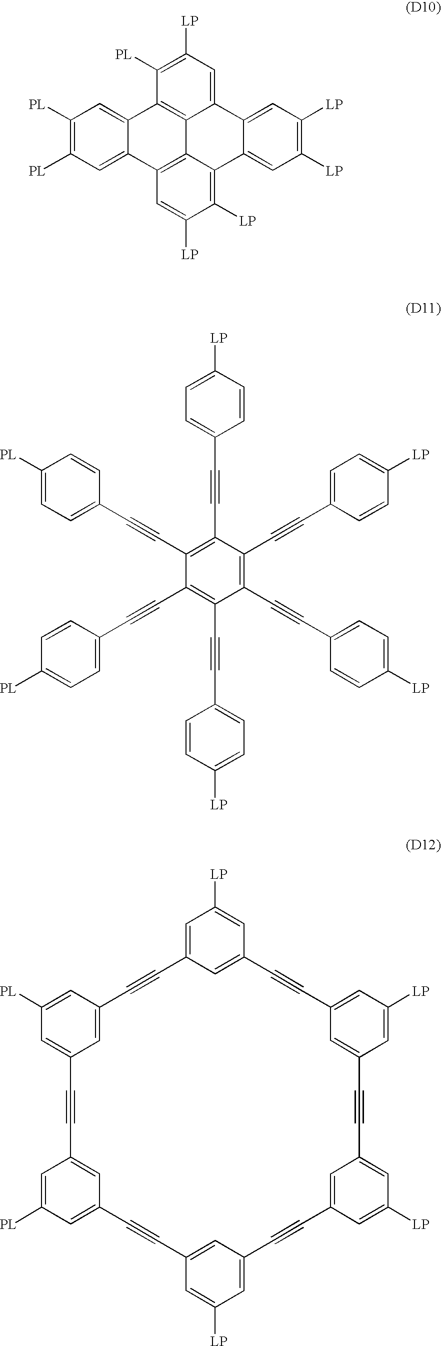

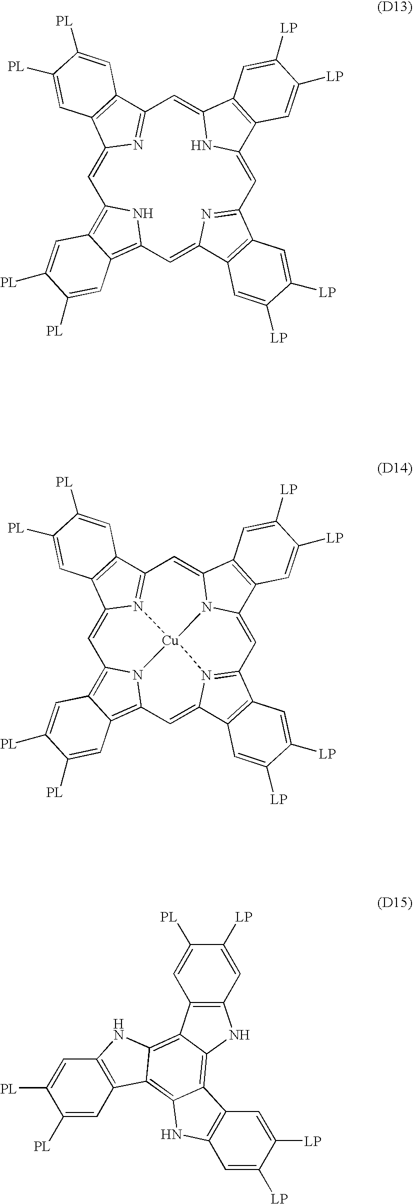

The divalent linkage group “L ” in Structural Formula (2) is not specifically limited and can be appropriately selected according to the purpose. Preferred examples thereof are an alkylene group, an alkenylene group, arylene group, —CO—, —NH—, —O—, —S— and a combination of these groups, of which an alkylene group, an alkenylene group, an arylene group, —CO—, —NH—, —O—, —S—, and a divalent linkage group comprising at least two of these divalent groups are more preferred. Among them, an alkylene group, an alkenylene group, an arylene group, —CO—, —O—, and a divalent linkage group comprising at least two of these divalent groups are specifically preferred.

The alkylene group preferably has one to twelve carbon atoms. The alkenylene group preferably has two to twelve carbon atoms. The arylene group preferably has six to ten carbon atoms. Each of the alkylene group, the alkenylene group and the arylene group may have one or more substituents such as alkyl groups, halogen atoms, cyano group, alkoxy groups and acyloxy groups.

Specific examples of the divalent linkage group L are AL-CO—O-AL-, -AL-CO—O-AL-O—, -AL-CO—O-AL-O-AL-, -AL-CO—O-AL-O—CO—, —CO-AR—O-AL-, —CO-AR—O—AL—O—, —CO-AR—O-AL-O—CO—, —CO—NH-AL-, —N H-AL-O—, —NH-AL-O—CO—, —O-AL-, —O-AL-O—, —O-AL-O—CO—, —O-AL-O—CO—NH-AL-, —O-AL-S-AL-, —O—CO-AL-AR—O-AL-O —CO—, —O—CO-AR—O-AL—CO-, —O—CO-AR—O-AL-O—CO—, —O—CO-AR—O-AL-O-AL-O—CO—, —O—CO-AR—O-AL—O-AL-O-AL-O—CO—, —S-AL-, —S-AL-O—, —S-AL-O—CO—, —S-AL-S-AL and —S-AR-AL-.

In the specific examples of the divalent linkage group “L”, the left hand is bound to the discotic core “D”, and the right hand is bound to the polymerizable group P. The symbol AL represents an alkylene group or an alkenylene group; and AR represents an arylene group.

The polymerizable group P in Structural Formula (2) is not specifically limited and can be appropriately selected according to the type of the polymerization reaction. Preferred examples thereof are an unsaturated polymerizable group and epoxy group, of which an ethylenically unsaturated polymerizable group is more preferred. Specific examples of the polymerizable group P are polymerizable groups represented by following Structural Formulae (P1) to (P18): 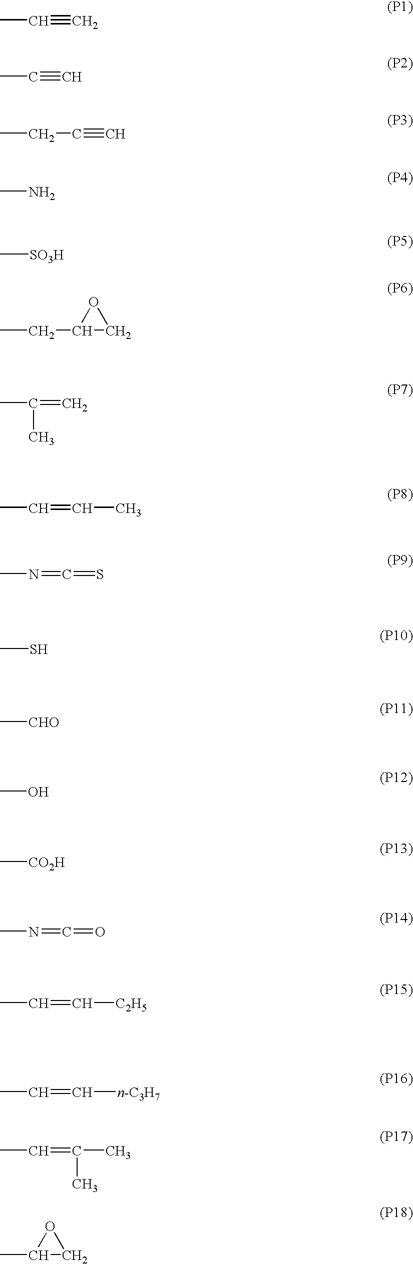
wherein n represents an integer of 4 to 12 and is determined according to the type of the discotic core “D”.

The other components which the polymerizable liquid crystal compound may comprise are not specifically limited, can be appropriately selected according to the purpose and include, for example, a polymerization initiator for initiating the polymerization reaction of the polymerizable liquid crystal compound, and a solvent for preparing a coating composition of the polymerizable liquid crystal compound.

The polymerization initiator is not specifically limited and can be appropriately selected according to the purpose. Suitable examples thereof are a thermal polymerization initiator for initiating a thermal polymerization reaction, and a photopolymerization initiator for initiating a photopolymerization reaction, of which the photopolymerization initiator is more preferred.

Specific examples of the photopolymerization initiator are α-carbonyl compounds described in U.S. Pat. No. 2,367,661 and No. 2,367,670; acyloin ethers described in U.S. Pat. No. 2,448,828; α-hydrocarbon-substituted aromatic acyloin compounds described in U.S. Pat. No. 2,722,512; polynuclear quinone compounds described in U.S. Pat. No. 3,046,127 and No. 2,951,758; combinations of a triarylimidazole dimer and p-aminophenyl ketone described in U.S. Pat. No. 3,549,367; acridine and phenazine compounds described in JP-A No. 60-105667 and U.S. Pat. No. 4,239,850; and oxadiazole compounds described in U.S. Pat. No. 4,212,970.

The content of the photopolymerization initiator in the polymerizable liquid crystal compound is not specifically limited, can be appropriately selected according to the purpose and is, for example, preferably 0.01 to 20 percent by weight and more preferably 0.5 to 5 percent by weight of the solid content of the coating composition for the polymerizable liquid crystal compound.

Light irradiating means for use in the photopolymerization reaction is not specifically limited, can be appropriately selected according to the purpose and is, for example, preferably ultraviolet rays. The irradiation energy of the light irradiating means is preferably 20 mJ/cm² to 50 mJ/cm² and more preferably 100 mJ/cm² to 800 mJ/cm².

The light irradiation may be carried out with heating, for accelerating the photopolymerization reaction.

The solvent is not specifically limited, can be appropriately selected according to the purpose, and suitable examples thereof are organic solvents. Specific examples of the organic solvents are amides such as N,N-dimethylformamide, N,N-dimethylacetamide and N-methylpyrrolidone, sulfoxides such as dimethyl sulfoxide (DMSO); heterocyclic compounds such as pyridine; hydrocarbons such as benzene and hexane; alkyl halides such as chloroform and dichloromethane; esters such as methyl acetate and butyl acetate; ketones such as acetone, methyl ethyl ketone and methyl isobutyl ketone; ketoesters such as methyl acetoacetate and ethyl acetoacetate; ethers such as tetrahydrofuran, 1,2-dimethoxyethane, diethylene glycol diethyl ether and dipropylene glycol dimethyl ether; and cellosolves such as methyl cellosolve, ethyl cellosolve and butyl cellosolve, of which amides, ethers and ketones are more preferred. Each of these organic solvents can be used alone or in combination.

The polymerization method for the polymerizable liquid crystal compound is not specifically limited, can be appropriately selected according to the purpose and includes, for example, methods described in JP-A No. 08-27284 and No. 10-278123.

The other components or configurations which the second optically anisotropic layer may comprise are not specifically limited, can be appropriately selected according to the purpose and include, for example, an alignment layer for aligning the liquid crystal structure in the polymerizable liquid crystal compound. The polymerizable liquid crystal compound is preferably formed on or over an alignment layer typically by coating.

The alignment layer is not specifically limited, can be appropriately selected according to the purpose and includes, for example, a rubbed alignment layer comprising an organic compound (preferably a polymer); an alignment layer having a micro groove; an alignment layer comprising an organic compound, such as ω-tricosanoic acid, dioctadecyldimethylammonium chloride or methyl stearate, deposited according to a Langmuir-Blodgett method (LB film); an alignment layer comprising an inorganic compound deposited by oblique vapor deposition; and an alignment layer having an aligning function as a result of the application of an electric or magnetic field, or light. Among them, the rubbed alignment layer comprising an organic compound is preferred.

The rubbing can be carried out by any procedure selected according to the purpose. For example, the surface of the film comprising an organic compound is rubbed with paper or cloth several times in a certain direction.

The organic compound is not specifically limited, can be appropriately selected according to the alignment condition of the liquid crystal structure (particularly the angle of alignment) and includes, for example, a polymer for an alignment layer which does not reduce the surface energy of the resulting alignment layer, for horizontal alignment of the liquid crystal structure.

Preferred examples of the polymer for an alignment layer for aligning the liquid crystal structure in a direction perpendicular to the direction of rubbing are modified poly(vinyl alcohol)s (JP-A No. 2002-62427), acrylic copolymers (JP-A No. 2002-98836) and polyimides and polyamic acid (JP-A No. 2002-268068).

The alignment layer preferably has a reactive group for improving adhesion with the polymerizable liquid crystal compound and the support. The reactive group is not specifically limited and can be appropriately selected according to the purpose. For example, a reactive group may be introduced into a side chain of a repeating unit of the polymer for an alignment layer, or a cyclic group as a substituent may be introduced into the polymer for an alignment layer.

An alignment layer described in JP-A No. 09-152509 can be used as the alignment layer capable of forming a chemical bond with the polymerizable liquid crystal compound and the support by the action of a reactive group. The thickness of the alignment layer is not specifically limited, can be appropriately selected according to the purpose and is preferably 0.01 μm to 5 μm and more preferably 0.02 μm to 2 μm.

The second optically anisotropic layer can be prepared by any suitable method according to the purpose, such as a method in which a coating composition containing the polymerizable liquid crystal compound having the liquid crystal structure, the polymerization initiator and any other components in the solvent is applied to the alignment layer.

The coating composition can be applied to the alignment layer according to any suitable procedure such as extrusion coating, direct gravure coating, reverse gravure coating, die coating or spin coating.

The second optically anisotropic layer may be prepared by a method in which the polymerizable liquid crystal compound having the liquid crystal structure is aligned by using the alignment layer, liquid crystal molecules are fixed while maintaining them being aligned to form an optically anisotropic layer, and the optically anisotropic layer alone is transferred to a support such as a polymer film. The resulting second optically anisotropic layer prepared by this method can serve to optically compensate the liquid crystal layer under a condition for displaying black further precisely without considering the effect of birefringence caused by the alignment layer.

—Other Layers—

The other layers are not specifically limited, can be appropriately selected according to the purpose and include, for example, an antireflective layer, an oxygen barrier layer and an antistripping layer.

The antireflective layer serves to prevent deterioration of optical properties of the optical compensatory element comprising plural optically anisotropic layers.

Specifically, the element capable of optical compensation can be obtained by an appropriate combination of the support and the optically anisotropic layers. The refractive index of the material constituting the support is 1.45 in quartz glass and 1.76 in sapphire.

The first optically anisotropic layer comprising layers having different refractive indices is prepared so as to have a total refractive index of 0.5 or more. The organic compound constituting the second optically anisotropic layer generally has a refractive index of 1.4 to 1.8. The difference in refractive index among these layers constituting the optical compensatory element is inevitable.

The difference in refractive index may cause reflection of light from the light source between the layers to thereby reduce the quantity of light emitted from the element. In addition, if the element is arranged in the vicinity of the light source, it receives a large quantity of light from the light source and thus yields highly reflected light, which deteriorates the quality of an image.

The reflection of light caused by the difference in refractive index can be prevented and an excellent optical compensatory element can be obtained by incorporating the antireflective layer into the optical compensatory element. The antireflective layer is preferably arranged between two layers yielding a maximum difference in refractive index for better results. The antireflective layer is also preferably arranged on an outermost layer constituting the air interface of the optical compensatory element for further preventing the reflection of light.

The antireflective layer may have any suitable structure according to the purpose and may have, for example, a single layer structure or a multilayered structure.

The material for the antireflective layer is not specifically limited and can be appropriately selected according to the purpose, as long as it can reduce the reflection ratio and increase the transmittance. Suitable examples thereof from the viewpoint of durability are inorganic compounds and known antireflection coat films (AR films).

The material for the antireflective layer is not specifically limited, can be appropriately selected according to the purpose and includes, for example, materials listed in the first optically anisotropic layer.

The wavelength λ can be set according to each wavelength to be controlled, when the element is used for the projector of the present invention and the light from the light source is divided into radiations with wavelengths of red, green and blue and is controlled independently. In this case, the antireflective structure can be more easily designed, since the wavelength region requiring antireflection is smaller than the whole visible range.

The layers having the above-specified optical thickness can be prepared by any suitable method according to the purpose. For example, a material having a refractive index n is arranged so that the resulting layer has a thickness of d. The film of the layer can be prepared by any method appropriately selected according to the purpose and is suitably prepared by vapor deposition that can finely control the thickness, such as vacuum vapor deposition, ion-assisted vapor deposition, ion plating vapor deposition, ion beam sputtering vapor deposition and chemical vapor deposition.

—Configuration of Optical Compensatory Element—

The optical compensatory element can have any configuration appropriately selected according to the purpose. Preferred examples of the configuration are the following first, second, third, fourth, fifth, sixth, seventh and eighth configurations.

<Optical Compensatory Element According to First Configuration>

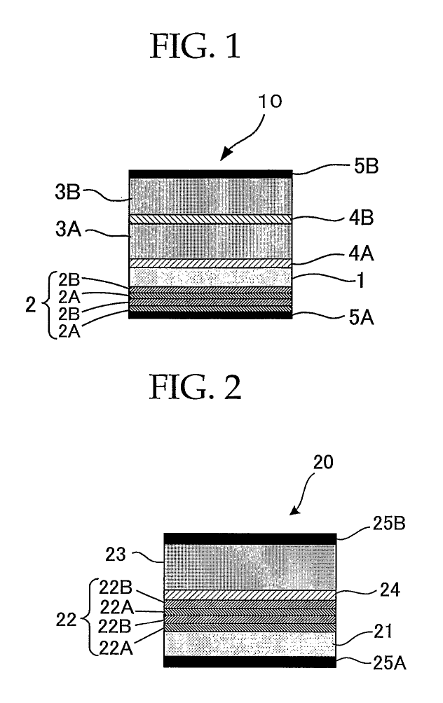

FIG. 1 is a sectional view schematically illustrating an optical compensatory element according to the first configuration of the present invention.

The optical compensatory element according to the first configuration comprises the support, the first optically anisotropic layer arranged on one side of the support, and two layers of the second optically anisotropic layers having different direction of alignments arranged on the other side of the support. Specifically, with reference to FIG. 1, an optical compensatory element 10 according to the first configuration comprises an alignment layer 4A, a second optically anisotropic layer 3A, an alignment layer 4B, a second optically anisotropic layer 3B and an antireflective layer 5B arranged in this order on or above one side of a support 1, so that the antireflective layer 5B constitutes an outermost surface. the optical compensatory element 10 further comprises a first optically anisotropic layer 2 and an antireflective layer 5A arranged in this order on or above the other side of the support 1 so that the antireflective layer 5A constitutes another outermost surface.

The first optically anisotropic layer 2 is an alternately multilayered structure comprising a TiO₂ layer 2A and a SiO₂ layer 2B. The thickness of the respective layers is about 15 nm. The first optically anisotropic layer 2 can also serve as an antireflective layer by having such an alternately multilayered structure.

The rubbing directions of the alignment layer 4A and the alignment layer 4B preferably differ from each other by 90 degrees. By arranging these alignment layers 4A and 4B, the direction of alignments of the liquid crystal structures in the polymerizable liquid crystal compounds of the second anisotropic layers 3A and 3B can differ from each other by 90 degrees.

<Optical Compensatory Element According to Second Configuration>

FIG. 2 is a sectional view schematically illustrating an optical compensatory element according to the second configuration of the present invention.

The optical compensatory element according to the second configuration comprises the first optically anisotropic layer and the second anisotropic layer arranged on or above at least one side of the support.

With reference to FIG. 2, an optical compensatory element 20 according to the second configuration comprises a first optically anisotropic layer 22, an alignment layer 24, a second optically anisotropic layer 23 and an antireflective layer 25B arranged in this order on or above one side of a support 21, so that the antireflective layer 25B constitutes an outermost surface, and comprises an antireflective layer 25A on the other side of the support 21.

The first optically anisotropic layer 22 can have a similar structure to that of the first optically anisotropic layer 2 in the optical compensatory element 10 according to the first configuration.

Two plies of the optical compensatory element 20 according to the second configuration can be used as a laminate. In this case, rubbing directions of the alignment layers in the respective optical compensatory elements preferably differ from each other by 90 degrees.

Such an optical compensatory element having the respective layers arranged on one side of the support, as in the optical compensatory element 20 according to the second configuration, can be generally satisfactorily handled and easily prepared, while these properties depend on the materials of the respective layers and combinations thereof.

<Optical Compensatory Element According to Third Configuration>

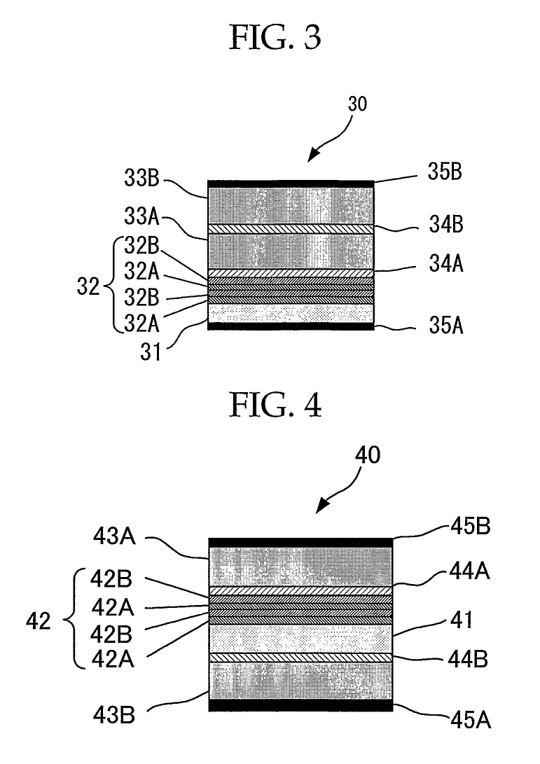

FIG. 3 is a sectional view schematically illustrating an optical compensatory element according to the third configuration of the present invention.

The optical compensatory element according to the third configuration comprises two second anisotropic layers having different direction of alignments arranged on one side of the support.

With reference to FIG. 3, an optical compensatory element 30 according to the third configuration comprises a first optically anisotropic layer 32, an alignment layer 34A, a second optically anisotropic layer 33A, an alignment layer 34B, a second optically anisotropic layer 33B and an antireflective layer 35B arranged in this order on or above one side of a support 31, so that the antireflective layer 35B constitutes an outermost surface, and comprises an antireflective layer 35A on the other side of the support 31.

The first optically anisotropic layer 32 can have a similar structure to that of the first optically anisotropic layer 2 in the optical compensatory element 10 according to the first configuration.

The rubbing directions of the alignment layer 34A and the alignment layer 34B preferably differ from each other by 90 degrees. By arranging these alignment layers 34A and 34B, the direction of alignments of the liquid crystal structures in the polymerizable liquid crystal compounds of the second anisotropic layers 33A and 33B can differ from each other by 90 degrees

<Optical Compensatory Element According to Fourth Configuration>

FIG. 4 is a sectional view schematically illustrating an optical compensatory element according to the fourth configuration of the present invention.

The optical compensatory element according to the fourth configuration comprises two second anisotropic layers having different direction of alignments arranged with the interposition of the support.

With reference to FIG. 4, an optical compensatory element 40 according to the fourth configuration comprises a first optically anisotropic layer 42, an alignment layer 44A, a second optically anisotropic layer 43A and an antireflective layer 45B arranged in this order on or above one side of a support 41, so that the antireflective layer 45B constitutes an outermost surface, and comprises an alignment layer 44B, a second optically anisotropic layer 43B, a protective layer 46A and an antireflective layer 45A in this order on or above the other side of the support 41.

The first optically anisotropic layer 42 can have a similar structure to that of the first optically anisotropic layer 2 in the optical compensatory element 10 according to the first configuration.

The rubbing directions of the alignment layer 44A and the alignment layer 44B preferably differ from each other by 90 degrees. By arranging these alignment layers 44A and 44B, the direction of alignments of the liquid crystal structures in the polymerizable liquid crystal compounds of the second anisotropic layers 43A and 43B can differ from each other by 90 degrees

<Optical Compensatory Element According to Fifth Configuration>

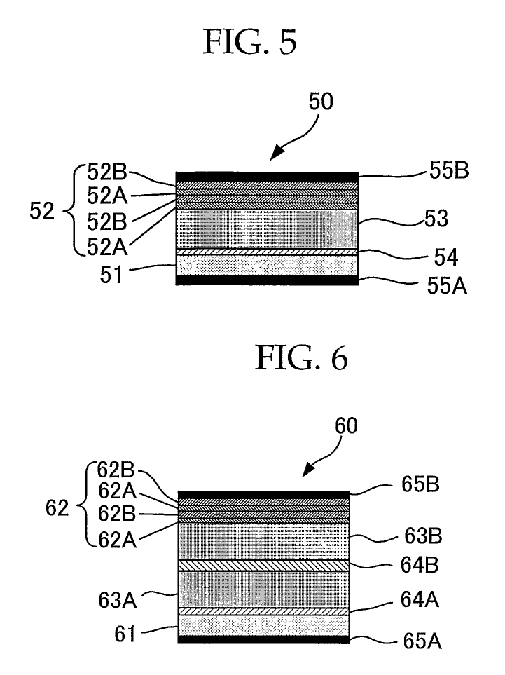

FIG. 5 is a sectional view schematically illustrating an optical compensatory element according to the fifth configuration.

The optical compensatory element according to the fifth configuration comprises the first optically anisotropic layer and the second anisotropic layer on or above at least one side of the support.

With reference to FIG. 5, an optical compensatory element 50 according to the fifth configuration comprises an alignment layer 54, a second optically anisotropic layer 53, a first optically anisotropic layer 52 and an antireflective layer 55B arranged in this order on or above one side of a support 51, so that the antireflective layer 55B constitutes an outermost surface, and comprises an antireflective layer 55A on or above the other side of the support 51.

The first optically anisotropic layer 52 can have. a similar structure to that of the first optically anisotropic layer 2 in the optical compensatory element 10 according to the first configuration.

Two plies of the optical compensatory element 50 according to the fifth configuration may be used as a laminate. In this case, rubbing directions of the alignment layers in the respective optical compensatory elements preferably differ from each other by 90 degrees.

<Optical Compensatory Element According to Sixth Configuration>

FIG. 6 is a sectional view schematically illustrating an optical compensatory element according to the sixth configuration of the present invention.

The optical compensatory element according to the sixth configuration comprises two second anisotropic layers having different direction of alignments. With reference to FIG. 6, an optical compensatory element 60 according to the sixth configuration comprises an alignment layer 64A, a second optically anisotropic layer 63A, an alignment layer 64B, a second optically anisotropic layer 63B, a first optically anisotropic layer 62 and an antireflective layer 65B arranged in this order on or above one side of a support 61, so that the antireflective layer 65B constitutes an outermost layer, and comprises an antireflective layer 65A on or above the other side of the support 61.

The first optically anisotropic layer 62 can have a similar structure to that of the first optically anisotropic layer 2 in the optical compensatory element 10 according to the first configuration.

The rubbing directions of the alignment layer 64A and the alignment layer 64B preferably differ from each other by 90 degrees. By arranging these alignment layers 64A and 64B, the direction of alignments of the liquid crystal structures in the polymerizable liquid crystal compounds of the second anisotropic layers 63A and 63B can differ from each other by 90 degrees

<Optical Compensatory Element According to Seventh Configuration>

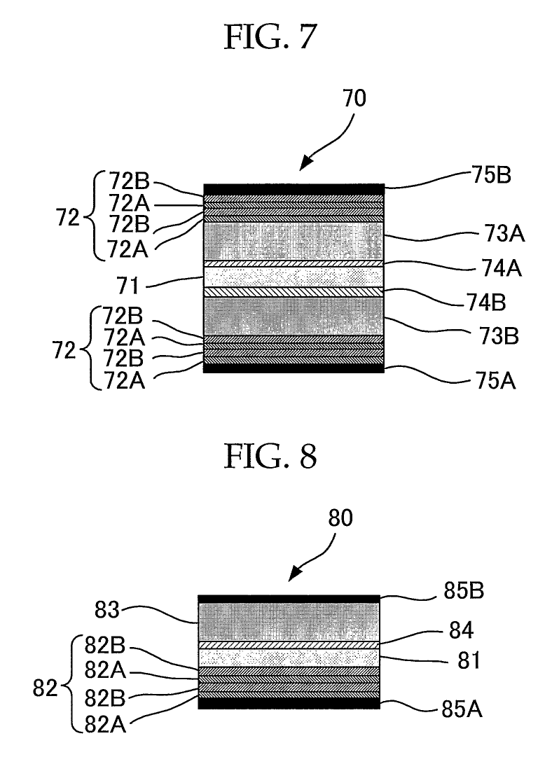

FIG. 7 is a sectional view schematically illustrating an optical compensatory element according to the seventh configuration of the present invention.

The optical compensatory element according to the seventh configuration comprises two second optically anisotropic layers having different direction of alignments arranged with the interposition of the support.

With reference to FIG. 7, an optical compensatory element 70 according to the seventh configuration comprises an alignment layer 74A, a second optically anisotropic layer 73A, a first optically anisotropic layer 72 and an antireflective layer 75B arranged in this order on or above one side of a support 71, so that the antireflective layer 75B constitutes an outermost layer, and comprises an alignment layer 74B, a second optically anisotropic layer 73B, a first optically anisotropic layer 72 and an antireflective layer 75A arranged in this order on or above the other side of the support 71, so that the antireflective layer 75A constitutes another outermost layer.

The first optically anisotropic layer 72 can have a similar structure to that of the first optically anisotropic layer 2 in the optical compensatory element 10 according to the first configuration. The element has only to comprise at least one first optically anisotropic layer 72, and one of the two first optically anisotropic layers 72 can be omitted.

The rubbing directions of the alignment layer 74A and the alignment layer 74B preferably differ from each other by 90 degrees. By arranging these alignment layers 74A and 74B, the direction of alignments of the liquid crystal structures in the polymerizable liquid crystal compounds of the second anisotropic layers 73A and 73B can differ from each other by 90 degrees

<Optical Compensatory Element According to Eighth Configuration>

FIG. 8 is a sectional view schematically illustrating an optical compensatory element according to the eighth configuration of the present invention.

The optical compensatory element according to the eighth configuration comprises the first optically anisotropic layer on or above one side of the support, and the second optically anisotropic layer on or above the other side of the support.

With reference to FIG. 8, an optical compensatory element 80 according to the eighth configuration comprises an alignment layer 84, a second optically anisotropic layer 83 and an antireflective layer 85B arranged in this order on or above one side of a support 81, so that the antireflective layer 85B constitutes an outermost layer, and comprises a first optically anisotropic layer 82 and an antireflective layer 85A arranged in this order on or above the other side of the support 81, so that the antireflective layer 85A constitutes an outermost layer.

The first optically anisotropic layer 82 can have a similar structure to that of the first optically anisotropic layer 2 in the optical compensatory element 10 according to the first configuration.

Two plies of the optical compensatory element 80 according to the eighth configuration can be used as a laminate. In this case, rubbing directions of the alignment layers in the respective optical compensatory elements preferably differ from each other by 90 degrees.

In the optical compensatory elements, the optical properties of the first optically anisotropic layers 2, 22, 32, 42, 52, 62, 72 and 82 are determined depending on the pitch of alternate structure of the alternately multilayered structures comprising inorganic materials. Thus, these optical compensatory elements avoid optical ununiformity, such as variation of refractive index or reduced haze, have highly uniform optical properties in the plane of the first optically anisotropic layer and can thereby optically compensate the liquid crystal layer under a condition for displaying black more precisely. Such optical ununiformity occurs in a plane of a polymer film due to residual stress when the polymer film is uniaxially stretched to yield predetermined optical properties.

The first optically anisotropic layers 2, 22, 32, 42, 52, 62, 72 and 82 can be controlled in their in-plane thickness within a range of ten and several nanometers, can have high smoothness and can have higher optical uniformity in plane. The optical compensatory elements thereby can optically compensate the liquid crystal layer under a condition for displaying black more precisely, reduce light leakage and prevent streaky unevenness.

In addition, the first optically anisotropic layers 2, 22, 32, 42, 52, 62, 72 and 82 do not swell or shrink even in use at high temperatures and high humidity over a long time.

In particular, the optical compensatory elements according to the first, second and third configurations have the first optically anisotropic layers 2, 22 and 32 on or above the supports 1, 21 and 31, and the in-plane thickness of these first optically anisotropic layers can be controlled within a range of ten and several nanometers. Thus, the first optically anisotropic layers 2, 22 and 32 can prevent unevenness in the in-plane thickness highly precisely and have highly smooth surfaces. The second optically anisotropic layers 3, 23 and 33 are arranged adjacent to the first optically anisotropic layers 2, 22 and 32 having such highly smooth surfaces and can be prevented from in-plane alignment failure. The resulting optical compensatory elements can optically compensate the liquid crystal layer under a condition for displaying black more precisely, prevent light leakage at a wider viewing angle and be usable typically in large-screen liquid crystal monitors and liquid crystal projectors which require a wide viewing angle. The resulting liquid crystal displays and liquid crystal projectors can produce high-quality images at high contrast.

(Method for Manufacturing Optical Compensatory Element)

The method for manufacturing an optical compensatory element of the present invention comprises the processes of laminating plural layers on or above a support in a regular order, the plural layers each comprising one or more inorganic materials and having different refractive indices to yield the first optically anisotropic layer, and polymerizing a polymerizable liquid crystal compound having a liquid crystal structure while keeping the liquid crystal structure being aligned to yield the second optically anisotropic layer. The method may further comprise any other processes according to necessity.

The optical compensatory element may be manufactured by forming the first optically anisotropic layer directly on a plane of the support and forming the second optically anisotropic layer on or above the first optically anisotropic layer or may be manufactured by forming the second optically anisotropic layer above a plane of the support with the interposition of the alignment layer and forming the first optically anisotropic layer on or above the second optically anisotropic layer. It may also be manufactured by forming the first optically anisotropic layer directly on one side of the support and forming the second optically anisotropic layer on or above the other side of the support or may be manufactured by forming the second optically anisotropic layer directly on one side of the support and then forming first optically anisotropic layer on or above the other side of the support.

A specific example of the method for manufacturing an optical compensatory element is as follows.

Initially, a first optically anisotropic layer is formed on a glass substrate having a predetermined size. The first optically anisotropic layer can be prepared by any procedure appropriately selected according to the purpose and is prepared, for example, by forming and laminating a TiO₂ layer and a SiO₂ layer alternately by vapor deposition to thereby form an alternately multilayered structure. The thickness of the respective layers in the first optically anisotropic layer is not specifically limited, can be appropriately selected according to the purpose and is, for example, each about 15 nm.

Next, an alignment layer is formed on the laminated first optically anisotropic layer by applying a solution of a modified poly(vinyl alcohol) thereto. The surface of the formed alignment layer is rubbed with a cloth in one direction to impart the function of aligning thereto.

Next, a solution of a polymerizable liquid crystal compound having a liquid crystal structure is applied to the alignment layer with the use of, for example, a bar coater, a spin coater or a die coater. The applied layer is heated to remove the solvent by drying, the heating temperature is then changed to thereby age the alignment of the liquid crystal structure, and ultraviolet rays are applied to polymerize the polymerizable liquid crystal compound. Thus, the alignment of the liquid crystal structure is fixed to thereby yield a second optically anisotropic layer. The removal of the solvent from the solution of the polymerizable liquid crystal compound, and the alignment of the liquid crystal structure can be carried out under the same heating condition.

To manufacture an optical compensatory element having two second optically anisotropic layers on or above one side of the glass substrate, another alignment layer is formed on the second optically anisotropic layer by the same procedure as in the alignment layer, and another second optically anisotropic layer is then formed on the other alignment layer by the procedure as in the second optically anisotropic layer. The two alignment layers are preferably arranged so as to have direction of alignments differing from each other by 90 degrees.

Then the antireflective layer is formed on the second optically anisotropic layer and on the other side (backside) of the glass substrate by applying or vapor-depositing a material for the antireflective layer comprising one or more organic or inorganic materials thereto. Thus, the optical compensatory element is manufactured.

(Liquid Crystal Display)

The liquid crystal display of the present invention comprises a liquid crystal device comprising at least one pair of electrodes and a liquid crystal molecule encapsulated in between the at least one pair of electrodes, an optical compensatory element arranged on or above at least one side of the liquid crystal device, and at least one polarizing element facing the liquid crystal device and the optical compensatory element, in which the optical compensatory element is the optical compensatory element of the present invention. It may further comprise any other components or configurations.

The display mode of the liquid crystal device is not specifically limited, can be appropriately selected according to the purpose and includes, for example, a twisted nematic (TN) mode, a vertical alignment (VA) mode, an in-plane switching (IPS) mode, an optically compensatory bend (OCB) mode, and an electrically controlled birefringence (ECB) mode, of which a TN mode is preferably employed for high contrast ratio.

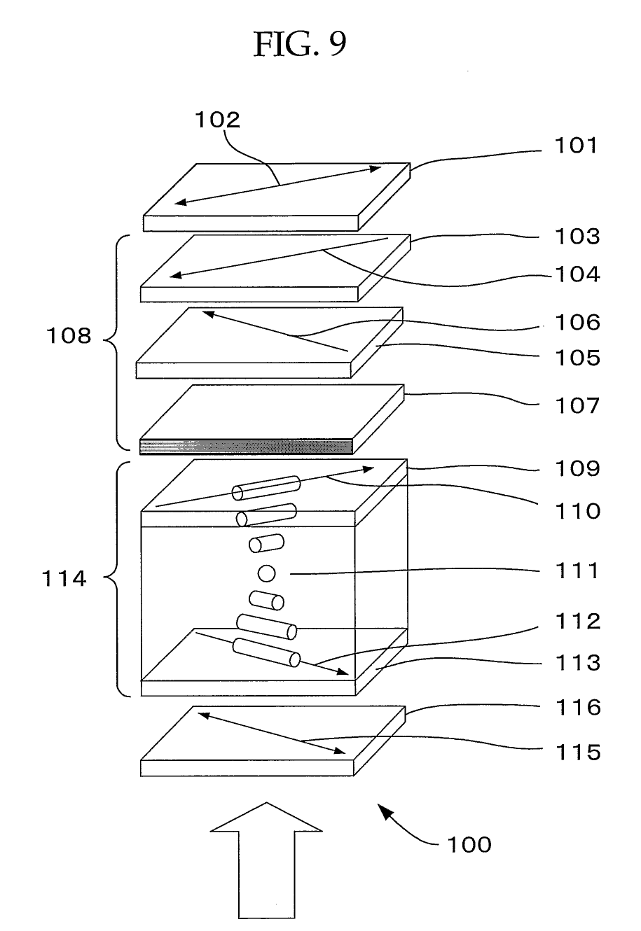

FIGS. 9 to 12 are schematic diagrams illustrating the liquid crystal display of the present invention.

For the sake of understanding, the schematic diagrams of the liquid crystal displays in these drawings show that light emitted from a light source comes into the liquid crystal display from lower side of the drawings and travels toward upper side of the drawings. When the polarizing plate and/or the second optically anisotropic layer comprises two components, one present in the upper side in the drawings is called as “upper” component, and the other present in the lower side in the drawings is called as “lower” component.

With reference to FIG. 9, a liquid crystal display 100 comprises a pair of a upper polarizing element 101 (analyzer) and a lower polarizing element 116 (polarizer), an optical compensatory element 108 arranged between the upper and lower polarizing elements 101 and 116 and a liquid crystal device (liquid crystal cell) 114. The upper and lower polarizing elements 101 and 116 are arranged so as to face each other and have adsorption axes 102 and 115 substantially perpendicular to each other in a cross nicol manner.

Polarization beam splitters such as Glan-Thompson prisms may be arranged as the polarizing element instead of the upper and lower polarizing elements 101 and 116 so as to sandwich the liquid crystal device 114.

The liquid crystal device 114 comprises an upper substrate 109 and a lower substrate 113, and a nematic liquid crystal 111, for example, encapsulated in between these upper and lower substrates 109 and 113. The upper and lower substrates 109 and 113 each comprise a glass substrate and are arranged so as to face each other. The upper substrate 109 and the lower substrate 113 have components (not shown) such as picture electrodes and circuit elements (thin-film transistors) on their planes facing each other. The upper substrate 109 and the lower substrate 113 further have upper and lower alignment layers (not shown), respectively, on their planes adjacent to the nematic liquid crystal 111. The planes of the alignment layers adjacent to the nematic liquid crystal 111 have been rubbed for aligning the directions of alignment of liquid crystal molecules. The directions of rubbing 110 and 112 in the upper and lower alignment layers, i.e., the direction of grooves formed as a result of rubbing are substantially perpendicular to each other, for example, in the case of a liquid crystal display of a TN mode.

FIG. 9 illustrates the arrangement of liquid crystal molecules under a normal condition where no voltage is applied to the liquid crystal device 114. Liquid crystal molecules in the nematic liquid crystal 111 near to the upper substrate 109 and to the lower substrate 113 are arranged in directions substantially identical to the directions of rubbing 110 and 112 by the action of rubbing on the alignment layers (not shown). Thus, the liquid crystal molecules in the nematic liquid crystal 111 are aligned so as to have major axes, whose directions are twisted by 90 degrees from the upper substrate 109 toward the lower substrate 113, since the directions of rubbing 110 and 112 are perpendicular to each other.

The optical transmittance of the polarizing elements in a cross nicol arrangement is preferably 0.001% or less, provided that that in a parallel Nicol arrangement is defined as 100%.

The upper polarizing element 101 (analyzer) and the lower polarizing element 116 (polarizer) each comprises at least a polarizing film and may further comprise any other components according to necessity.

The polarizing film is not specifically limited, can be appropriately selected according to the purpose and includes, for example, a stretched film made from a hydrophilic polymer which has adsorbed a dichroic material and has been subjected to stretching for alignment. Examples of the hydrophilic polymer are poly(vinyl alcohol)s, partially formalized poly(vinyl alcohol)s, and partially saponified products of ethylene-vinyl acetate copolymers. Examples of the dichroic material are iodine and dichroic dyes such as azo dyes, anthraquinone dyes and tetrazine dyes.

The stretching procedure can be carried out by using any device appropriately selected according to the purpose, such as a lateral uniaxial tenter stretching machine in which the adsorption axis of the polarizing film is substantially perpendicular to the longitudinal direction. The lateral uniaxial tenter stretching machine is advantageous in that it can avoid foreign matter entering during lamination.

A stretching method described in JP-A No. 2002-131548 can be employed in the stretching for alignment.

The other components are not specifically limited, can be appropriately selected according to the purpose and include, for example, a transparent protective layer, an antireflective layer and/or an anti-glare layer each arranged on or above at least one side of the polarizing film.

Each of the upper and lower polarizing elements 101 and 116 is preferably a polarizing plate having the transparent protective layer on or above at least one side of the polarizing film or an integrated article comprising the liquid crystal device 114 as a support, and the polarizing film arranged on or above one side of the liquid crystal device 114.

The material for the transparent protective layer is not specifically limited, can be appropriately selected according to the purpose and includes, for example, cellulose esters such as cellulose acetate, cellulose acetate butyrate and cellulose propionate; polycarbonates; polyolefins; polystyrenes; and polyesters.

Suitable examples of the. material for the transparent protective layer are cellulose triacetate, and polyolefins such as ZEONEX and ZEONOR (both available from ZEON CORPORATION), and ARTON (available from JSR Corporation).

Non-birefringent optical resin materials described in JP-A No. 08-110402 and JP-A No. 11-293116 can be used herein.

The alignment axis (slow axis) of the transparent protective layer is arranged in any direction but is preferably in parallel with the longitudinal direction for easy and convenient operation. The angle formed between the slow axis (alignment axis) of the transparent protective layer and the adsorption axis (stretching axis) of the polarizing film is not specifically limited and can be appropriately set according to the target polarizing plate. When the polarizing film is prepared by using the lateral uniaxial tenter stretching machine, the slow axis (alignment axis) of the transparent protective layer is in a direction substantially perpendicular to the adsorption axis (stretching axis) of the polarizing film.

The retardation of the transparent protective layer is not specifically limited, can be appropriately set according to the purpose and is preferably, for example, 10 nm or less and more preferably 5 nm or less when measured by light having a wavelength of 632.8 nm.

The retardation of the cellulose acetate, if used, is preferably less than 3 nm and more preferably 2 nm or less for minimizing a variation of the retardation with temperature and humidity in the environment.

The polarizing plate can be prepared by any method appropriately selected according to the purpose and is preferably prepared by continuously laminating onto a long polarizing film fed as a roll so that the longitudinal directions meet each other.

The polarizing film and the polarizing plate are preferably fixed to the liquid crystal device for preventing misregistration of the optical axis and entering of foreign matter such as dust.

The antireflective layer is not specifically limited, can be appropriately selected according to the purpose and includes, for example, a coating layer of a fluorine-containing polymer, and an optical interference layer such as a multilayered metal layer prepared by vapor deposition.

The upper and lower polarizing elements 101 and 116 preferably have optical properties and durability (storage ability in short-time and long-time storage) equal to or higher than those of a commercially available high-contrast product, such as HLC2-5618 available from Sanritz Corporation.

The optical compensatory element 108 comprises the optical compensatory element of the present invention.

When the optical compensatory element is integrated into the liquid crystal display 100, the contrast ratio Vw/Vb in front of the liquid crystal display 100 is preferably 100:1 or more, more preferably 200:1 or more, and specifically preferably 300:1 or more. The contrast ratio Vw/Vb is the ratio of the transmittance of the liquid crystal display 100 in displaying white Vw to the transmittance in displaying black Vb.

The maximum transmittance in displaying black is preferably 10% or less, and more preferably 5% or less of Vw in an azimuth direction inclined 60° from the normal direction to the display plane of the liquid crystal display 100. By using the optical compensatory element having such properties, the resulting liquid crystal display exhibits a high contrast and a wide viewing angle without tone reversal.

To accurately compensate a liquid crystal device having a large residual twisted component, the liquid crystal display preferably does not quench in any direction and has an optical transmittance 0.01% or more in all directions when a wave plate is arranged between a pair of polarizing elements arranged in a cross nicol manner, and the wave plate is rotated with the normal direction to the wave plate as a rotation axis.

The optical compensatory element 108 is arranged between the upper polarizing element 101 and the liquid crystal device 114 and comprises a first optically anisotropic layer 107, an upper second optically anisotropic layer 103 and a lower second optically anisotropic layer 105.

The respective optically anisotropic layers constituting the optical compensatory element 108 are arranged so that the angle formed between a direction of rubbing 104 of an alignment layer in the upper second optically anisotropic layer 103 and a direction of rubbing 110 of an upper alignment layer in an upper substrate 109 of the liquid crystal device 114 is 180° and so that a direction of rubbing 106 of an alignment layer in the lower second optically anisotropic layer 105 and a direction of rubbing 112 of a lower alignment layer in a lower substrate 132 of the liquid crystal device 114 is 180°.

The directions of rubbing in the alignment layers in the second optically anisotropic layer and in the substrate of the liquid crystal device may be exchanged. More specifically, the layers may be arranged so that the angle formed between the direction of rubbing 106 of the alignment layer in the lower second optically anisotropic layer 105 and the direction of rubbing 110 of the upper alignment layer in the upper substrate 109 of the liquid crystal device 114 is 180° and so that the angle formed between the direction of rubbing 104 of the alignment layer in the upper second optically anisotropic layer 103 and the direction of rubbing 112 of the lower alignment layer in the lower substrate 113 of the liquid crystal device 114 is 180°.

The first optically anisotropic layer 107 is preferably arranged near to the liquid crystal device 114.

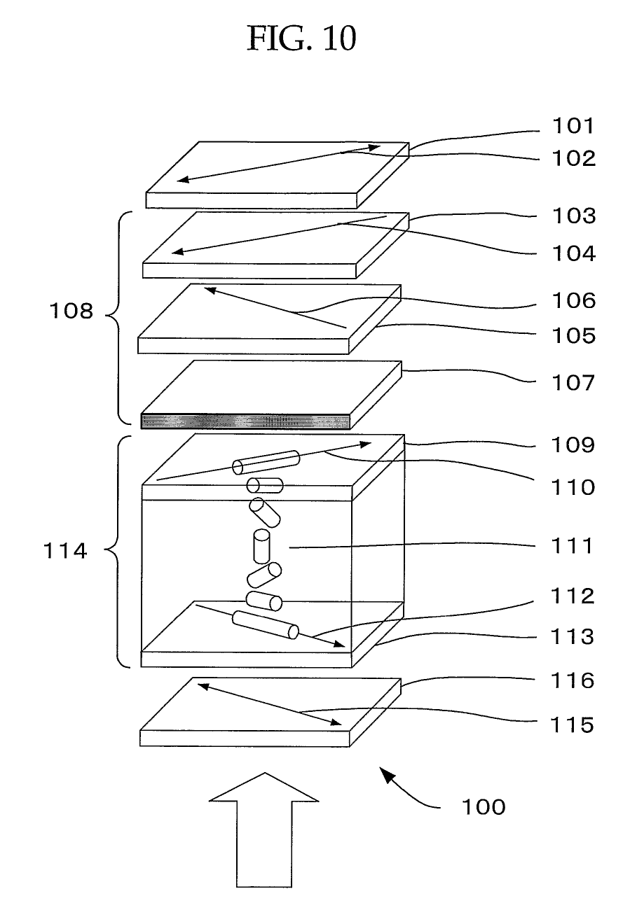

FIG. 10 schematically illustrates the arrangement of liquid crystal molecules in a liquid crystal display of a TN mode under a condition for displaying black, i.e., when a voltage is applied to the liquid crystal device 114. Upon application of a voltage to the liquid crystal device 114, the liquid crystal molecules change in their arrangement so that the liquid crystal molecules stand up with their major axes perpendicular to the incident plane of light. Ideally, all the liquid crystal molecules in the liquid crystal device 114 should preferably stand perpendicular to the incident plane of light upon application of a voltage. In actuality, however, the major axes of the liquid crystal molecules in the liquid crystal device 114 gradually become perpendicular to the incident plane of light from the upper substrate 109 and the lower substrate 113 toward the center part of the liquid crystal device 114, as shown in FIG. 10. Thus, liquid crystal molecules in the vicinity of the interfaces of the upper substrate 109 and of the lower substrate 113 are arranged so that their major axes are not perpendicular but oblique or inclined to the incident plane of light even upon application of a voltage. These liquid crystal molecules being inclined to the incident plane of light fail to display black and cause light leakage at some viewing angles.

In addition, nematic liquid crystal molecules for use in such a liquid crystal display of a TN mode are generally rod-shaped liquid crystal molecules and exhibit optically positive uniaxial properties. Accordingly, when the liquid crystal display 100 is viewed from an oblique direction, even the liquid crystal molecules at the center part of the liquid crystal device 114 stand up completely perpendicular to the incident direction of light cause birefringence, and the device fails to display black and causes light leakage at some viewing angles.

The birefringence caused by the alignment of the liquid crystal molecules in the liquid crystal device 114 in the vicinity of the interfaces of the upper substrate 109 and of the lower substrate 113 under a condition for displaying black can be optically compensated by allowing the alignment of the liquid crystal molecules in the second optically anisotropic layers 103 and 105 to be mirror symmetry. In addition, the birefringence caused by liquid crystal molecules at the center part of the liquid crystal device 114 can be optically compensated by arranging the first optically anisotropic layer 107 having optical properties as a not-inclined uniaxial ellipsoid having a negative refractive index. Thus, the liquid crystal device 114 under a condition for displaying black can be optically compensated three-dimensionally as a whole to thereby prevent light leakage in a wide range of viewing angles.

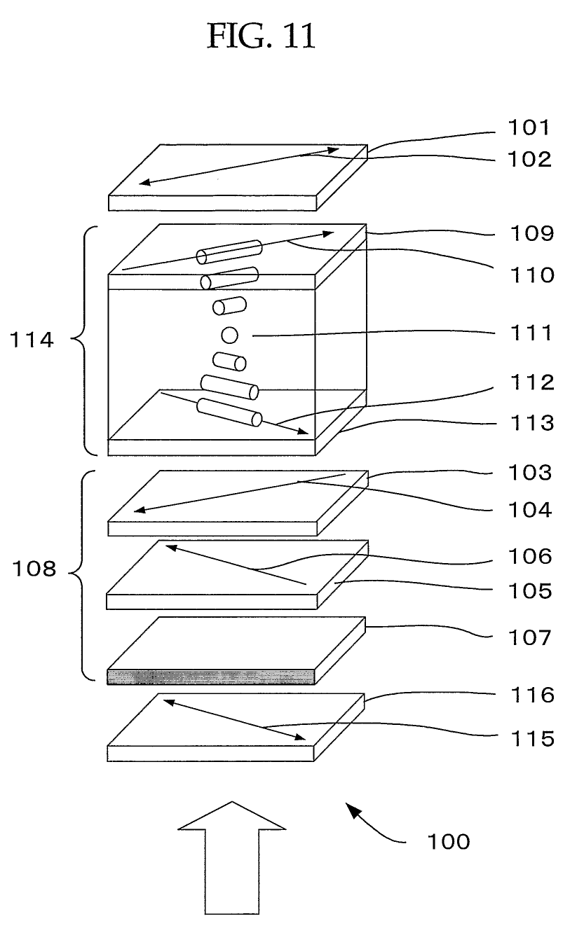

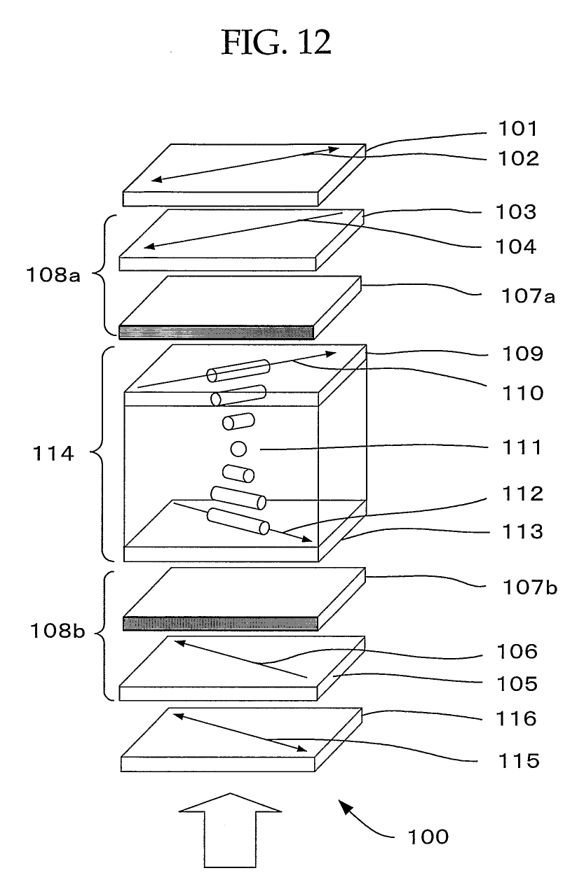

The optical compensatory element 108 can be arranged under the liquid crystal device 114 (FIG. 11) or can be arranged on and under the liquid crystal device 114 as optical compensator elements 108a and 108b (FIG. 12). When the optical compensator elements 108a and 108b are arranged on and under the liquid crystal device 114, one of first optically anisotropic layers 107a and 107b can be omitted. When both the first optically anisotropic layers 107a and 107b are arranged, the retardation is defined as a total of the retardations of these layers.

The optical compensatory element 108 can have the upper substrate 109 and the lower substrate 113 of the liquid crystal device 114 as the substrate (not shown). In this case, the first optically anisotropic layers 107a and 107b shown in FIG. 12 are directly arranged on the upper substrate 109 and the lower substrate 113, respectively.

(Liquid Crystal Projector)

The liquid crystal projector of the present invention is so configured that light from a light source is applied to a liquid crystal display to allow the liquid crystal display to optically modulate the light, and the modulated light is allowed to form an image on a screen by the action of a projection optical system so as to display the image, in which the liquid crystal display is the liquid crystal display of the present invention.

The type of the liquid crystal projector is not specifically limited, can be appropriately selected according to the purpose and includes, for example, a screen-projection front projector and a rear-projection television set. The type of the liquid crystal display for use in the liquid crystal projector is not specifically limited, can be appropriately selected according to the purpose and includes, for example, a transmission liquid crystal display and a reflective liquid crystal display.

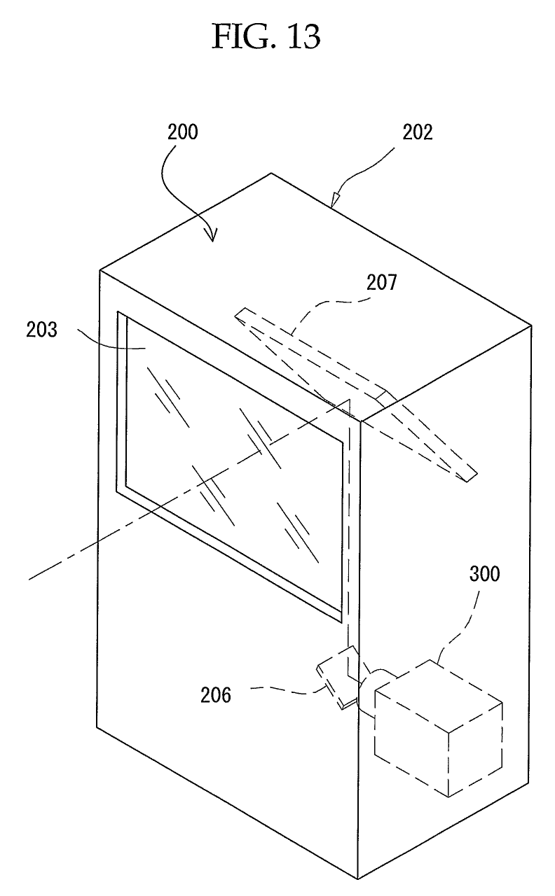

FIG. 13 is an outside view schematically illustrating a rear-projection liquid crystal projector.

With reference to FIG. 13, a liquid crystal projector 200 comprises a diffusional transmittance screen 203 in front of a cabinet 202. An image projected to the rear of the screen 203 is viewed from the front of the screen 203. The cabinet 202 houses a projection unit 300, and an image projected by the projection unit 300 is reflected by mirrors 206 and 207 to form an image on the rear side of the screen 203. The cabinet 202 of the liquid crystal projector 200 also houses other components (not shown) such as a tuner circuit and circuit units for reproducing video signals and voice signals.

The projection unit 300 includes a liquid crystal display(not shown) as an image display device. The liquid crystal display- serves to display a reproduced image of the video signal to thereby display an image projected on the screen 203.

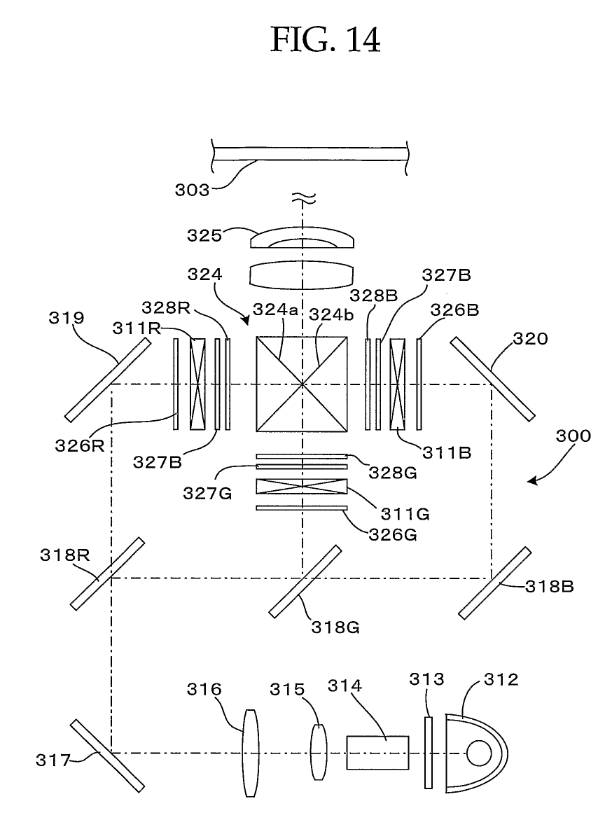

FIG. 14 is a schematic diagram illustrating a projection unit 300.

With reference to FIG. 14, the projection unit 300 comprises three transmittance liquid crystal devices 311R, 311G and 311B and can project full-color images.

Light emitted from a light source 312 passes through a filter 313 for cutting ultraviolet rays and infrared rays, becomes white light including red light, green light and blue light and comes into a glass rod 314 along an optical axis from the light source 312 to the liquid crystal devices 311R, 311G and 311B. The incident plane of light in the glass rod 314 is located in the vicinity of the focus of a parabolic mirror used in the light source 312, and the light from the light source 312 efficiently comes into the glass rod 314.

A relay lens 315 is arranged on a plane of emergence of the glass rod 314, and the white light going out from the glass rod 314 becomes parallel light by the action of the relay lens 315 and a subsequent collimate lens 316 and comes into a mirror 317.

The white light reflected by the mirror 317 is divided into two luminous fluxes by a dichroic mirror 318R transmitting red light alone, and the transmitted red light is reflected by a mirror 319 to illuminate a liquid crystal device 311R from the back.

The green light and the blue light reflected by the dichroic mirror 318R is further divided into two luminous fluxes by a dichroic mirror 318G transmitting green light alone. The green light reflected by the dichroic mirror 318G illuminates a liquid crystal device 311G from the backside. The blue light passing through the dichroic mirror 318G is reflected by mirrors 318B and 320 to illuminate a liquid crystal device 311B from the back.

The liquid crystal devices 311R, 311G and 311B each comprise a liquid crystal device of a TN mode, and the respective liquid crystal devices display light and dark patterns of a red image, a green image and a blue image, respectively, to constitute a full-color image. A composite prism 324 is arranged at a position at an optically equal distance from these liquid crystal devices 311R, 311G and 311B, and a projector lens 325 is arranged so as to face the outgoing plane of the composite prism 324. The composite prism 324 includes two dichroic planes 324a and 324b and serves to composite the red light passing through the liquid crystal device 311R, the green light passing through the liquid crystal device 311G and the blue light passing through the liquid crystal device 311B to allow the composite light to come into the projector lens 325.

The projector lens 325 is arranged on a projection light axis extending from the centers of outgoing planes of the liquid crystal devices 311R, 311G and 311B via the centers of the composite prism 324 and the projector lens 325 to the center of a screen 303. The projector lens 325 is arranged so that its objective focal plane agrees with the outgoing planes of the liquid crystal devices 311R, 311G and 311B and its imaging focal plane agrees with the screen 303. Thus, the full-color image composed by the composite prism 324 is allowed to form an image on the screen 303.

Polarizing plates 326R, 326G and 326B are arranged near to the incident planes of illuminated light of the liquid crystal devices 311R, 311G and 311B. Wave plates 327R, 327G and 327B, and polarizing plates 328R, 328G and 328B, respectively, are arranged near to the outgoing planes of the liquid crystal devices 311R, 311G and 311B. The polarizing plates 326R, 326G and 326B near to the incident planes are arranged in a cross nicol manner with respect to the polarizing plates 328R, 328G and 328B near to the outgoing planes. The polarizing plates 326R, 326G and 326B near to the incident planes serve as polarizers, and the polarizing plates 328R, 328G and 328B near to the outgoing planes serve as analyzers.

The liquid crystal display of the present invention comprises the liquid crystal devices 311R, 311G and 311B, the polarizing plates 326R, 326G, 326B, 328R, 328G and 328B, and the wave plates 327R, 327G and 327B.

The operations of the liquid crystal devices for respective color channels, and the polarizing plates and the wave plates sandwiching these liquid crystal devices, respectively, will be illustrated below by taking a red channel as an example. Because, the operations of these components arranged for respective color channels are basically identical, while there are some differences based on the colors.

The illuminated red light reflected by the mirror 319 is converted into linearly polarized light by the action of the polarizing plate 326R near to the incident plane and comes into the liquid crystal device 311R. In a normally white mode, a signal voltage is applied to a pixel to thereby allow a liquid crystal of a TN mode used in the liquid crystal device 311R to display black in a red image. In this procedure, liquid crystal molecules in the liquid crystal layer have various altitudes in their alignment. Thus, an image light outgoing from the outgoing plane of the liquid crystal device 311R does not become a fully linearly polarized light but an elliptically polarized light because of optical rotation and birefringence of the liquid crystal layer, even if the illuminated red light becomes a parallel pencil and comes into the liquid crystal device 311R. This causes light leakage from the polarizing plate 328R serving as the analyzer and fails to produce full black. In a normally black mode, slight inclination of the liquid crystal molecules causes insufficient black level.

When the light includes a component which passes through the liquid crystal molecules in the liquid crystal device in an oblique direction under a condition for displaying black, the image light modulated by the liquid crystal layer becomes elliptically polarized light having an optical phase slightly different from that of linearly polarized light. This causes light leakage from the polarizing plate 328R serving as the analyzer and fails to yield sufficient black level.

The liquid crystal projector of the present invention comprises the liquid crystal display of the present invention using the optical compensatory element of the present invention. Thus, the wave plate 327R serves to optically compensate the liquid crystal layer under a condition for displaying black more precisely and to prevent light leakage at a wider viewing angle.

The liquid crystal projector of the present invention can thereby yield a high-quality image at a high contrast and a wide viewing angle.

The present invention will, be illustrated in further detail with reference to several examples below, which are never intended to limit the scope of the present invention.

### EXAMPLE 1

<Preparation of Optical Compensatory Element>

An optical compensatory element was prepared by sequentially forming an alignment layer A, a second optically anisotropic layer A, an alignment layer B, a second optically anisotropic layer B and an antireflective layer A in this order on a front side of a glass substrate, and then sequentially forming a first optically anisotropic layer and an antireflective layer B in this order on the back of the glass substrate.

—Alignment Layer—

A coating composition for an alignment layer having the following composition was added dropwise onto the glass substrate to an amount of 100 ml/m² and was subjected to spin coating at 1000 rpm. The coating composition for an alignment layer was then dried with a hot air at 100° C. for three minutes to form an alignment layer 600 nm thick. The alignment layer was subjected to rubbing process to yield the alignment layer A aligned in a predetermined direction of alignment.

[Coating Composition for Alignment Layer]

| | | |
|---|---|---|
| Modified poly(vinyl alcohol) of following Structural Formula | 20 | g |
| (3) | | |
| Water (solvent) | 360 | g |
| Methanol | 120 | g |
| Glutaraldehyde (crosslinking agent) | 1.0 | g |

Modified poly(vinyl alcohol)

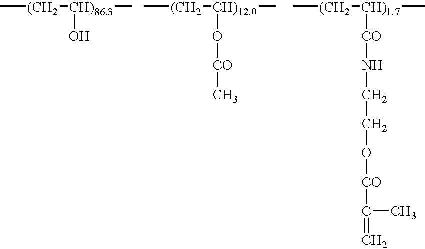

Structural Formula (3)

—Second Optically Anisotropic Layer—

A coating composition for a polymerizable liquid crystal compound was prepared by dissolving 4.27 g of a discotic liquid crystal compound of following Structural Formula (4), 0.42 g of ethylene oxide-modified trimethylolpropane triacrylate (V#360, available from saka Organic Chemical Industry Ltd.), 0.09 g of cellulose acetate butyrate (CAB551-0.2, available from Eastman Chemical Company), 0.02 g of cellulose acetate butyrate (CAB531-1, available from Eastman Chemical Company), 0.14 g of a photopolymerization initiator (IRGACURE 907, available from Chiba Geigy Ltd.) and 0.05 g of a sensitizing agent (Kayacure DETX-S, available from Nippon Kayaku Co., Ltd.) in 15.0 g of methyl ethyl ketone as a solvent.

The coating composition for a polymerizable liquid crystal compound was added dropwise to the alignment layer in an amount of 100 ml/m² and was subjected to spin coating at 1500 rpm, followed by heating in a thermostat zone at 130° C. to thereby align the polymerizable liquid crystal compound. The polymerizable liquid crystal compound was then polymerized to thereby fix the alignment of liquid crystal molecules by applying ultraviolet rays at an irradiation energy of 300 mJ/cm² using a high pressure mercury lamp. The resulting article was gradually cooled to room temperature to thereby yield the second optically anisotropic layer A.

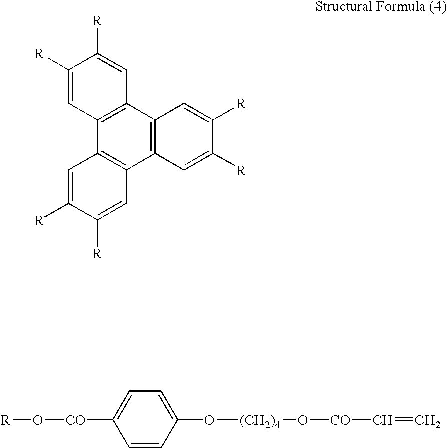

In the resulting second optically anisotropic layer A, the discotic liquid crystal compound was hybrid aligned, since the angle (angle of alignment) formed by the normal line of the normal axis of the disc plane with the normal line of the glass substrate increases from 10° to 62° from the glass substrate toward the air interface side.

The angle of alignment of the discotic liquid crystal compound was determined by determining retardations at a varying observation angle using an ellipsometer (M-150, available from JASCO Corporation), assuming a refractive index ellipsoid model based on the determined retardations and calculating the angle of alignment according to a technique described in “Design Concepts of the Discotic Negative Birefringence Compensation Films SID98DIGEST”.

The alignment layer B was then formed on the second optically anisotropic layer A so that the direction of alignment of the alignment layer B is substantially perpendicular to that of the alignment layer A. The second optically anisotropic layer B was formed on the alignment layer B according to the same procedure as in the second optically anisotropic layer A.

In the second optically anisotropic layer B, the discotic liquid crystal compound was hybrid-aligned, since the angle (angle of alignment) formed by the normal axis of the disc plane with the normal line of the glass substrate increases from 12° to 65° from the glass substrate side toward the air interface side. In addition, the second optically anisotropic layer B was a homogenous layer without defects such as schlieren.

—First Optically Anisotropic Layer—

The first optically anisotropic layer having an alternately multilayered structure was prepared by depositing layers of SiO₂ and TiO₂ in alternate manner on the opposite side of the substrate to the second optically anisotropic layers A and B by vapor deposition using a sputtering machine. More specifically, each twenty-six layers of SO₂ and of TiO₂ were formed, namely, a total of fifty-two layers were formed. The resulting first optically anisotropic layer has a total thickness of 760 nm and a retardation Rth of 200 nm.

—Antireflective Layer—

The antireflective layer B and the antireflective layer A were formed on the first optically anisotropic layer and the second optically anisotropic layer B, respectively, by depositing layers of SiO₂ and of TiO₂ alternately by vapor deposition under reduced pressure using a sputtering machine. The resulting antireflective layers A and B each have a thickness of 0.24 μm.

Liquid Crystal Display

A liquid crystal display according to Example 1 was prepared by laminating the above-prepared optical compensatory element onto a liquid crystal device of a TN mode in a normally white mode at a voltage to display white of 1.5 V and a voltage to display black of 3 V.

### EXAMPLE 2

A liquid crystal display was prepared by the procedure of Example 1, except for forming an alignment layer A, a second optically anisotropic layer A, an alignment layer B, a second optically anisotropic layer B, a first optically anisotropic layer and an antireflective layer A in this order on the front side of a glass substrate, and forming an antireflective layer B on the back of the glass substrate.

### EXAMPLE 3

A liquid crystal display was prepared by the procedure of Example 1, except for forming a first optically anisotropic layer, an alignment layer A, a second optically anisotropic layer A, an alignment layer B, a second optically anisotropic layer B and an antireflective layer in this order on one side of a glass substrate.

### EXAMPLE 4

A liquid crystal display was prepared by the procedure of Example 1, except for forming an alignment layer A, a second optically anisotropic layer A, a first optically anisotropic layer, an alignment layer B, a second optically anisotropic layer B and an antireflective layer A in this order on a front side of a glass substrate and forming an antireflective layer B on the back of the glass substrate.

### EXAMPLE 5

A liquid crystal display was prepared by the procedure of Example 1, except for forming an alignment layer A, a second optically anisotropic layer A and an antireflective layer A in this order on a front side of a glass substrate and forming an alignment layer B, a second optically anisotropic layer B, a first optically anisotropic layer and an antireflective layer B in this order on the back of the glass substrate.

### EXAMPLE 6

A liquid crystal display was prepared by the procedure of Example 1, except for forming an alignment layer A, a second optically anisotropic layer A and an antireflective layer A in this order on a front side of a glass substrate and forming a first optically anisotropic layer, an alignment layer B, a second optically anisotropic layer B, and an antireflective layer B in this order on the back of the glass substrate.

### EXAMPLE 7

A liquid crystal display was prepared by the procedure of Example 5, except for using a coating composition for an alignment layer having the following composition as the coating composition for an alignment layer.

[Coating Composition for Alignment Layer]

Sunever 150 (available from Nissan Chemical Industries, Ltd.)

20 g

Solvent for polyimide (available from Nissan Chemical Industries, Ltd.)

20 g

### COMPARATIVE EXAMPLE 1

A liquid crystal display was prepared by the procedure of Example 1, except for using a triacetyl cellulose (TAC) film instead of the first optically anisotropic layer in the optical compensatory element.

Determination of Viewing Angle Dependency of Liquid Crystal Display

The contrast ratio of each of the liquid crystal displays according to Examples 1 to 7 and Comparative Example 1 was determined at a position with an angle of elevation of 20° and an azimuth angle of 45° from the front of the display plane using a conoscope (available from Autronic-Melcher GmbH). The contrast ratio is the ratio of the transmittance in displaying white to the transmittance in displaying black with respect to the backlight. The results are shown in Table 1.

Determination of Contrast of Liquid Crystal Projector

Each three liquid crystal displays corresponding to red, green and blue colors according to Examples 1 to 7 and Comparative Example 1 were integrated into liquid crystal projectors of a TN mode to yield liquid crystal projectors according to Example 8 to 14 and Comparative Example 2, respectively. The illuminance intensities and contrast ratios (transmittance in displaying white/transmittance in displaying black) of the liquid crystal projectors on the screen plane with respect to projected light to display white and projected light to display black were determined. The results are shown in Table 1.

TABLE 1

| Liquid Crystal Display | | | | | |
|---|---|---|---|---|---|
| | Viewing | | | | |
| | angle | Liquid Crystal Projector | | | |
| | dependency | | White | Black | Contrast |
| | Contrast | | luminance | luminance | ratio |
| | ratio (%) | | (lux) | (lux) | (%) |
| Example 1 | 238 | Example 8 | 1300 | 1.9 | 680:1 |
| Example 2 | 232 | Example 9 | 1300 | 1.9 | 680:1 |
| Example 3 | 232 | Example 10 | 1300 | 1.9 | 680:1 |
| Example 4 | 232 | Example 11 | 1300 | 1.9 | 680:1 |
| Example 5 | 232 | Example 12 | 1300 | 1.9 | 680:1 |
| Example 6 | 232 | Example 13 | 1300 | 1.9 | 680:1 |
| Example 7 | 232 | Example 14 | 1300 | 1.9 | 680:1 |
| Comp. Ex. | 238 | Comp. Ex. 2 | 1300 | 1.9 | 680:1 |
| 1 | | | | | |

Table 1 shows that the liquid crystal displays according to Examples 1 to 7 each have a wider viewing angle and an equivalent viewing angle dependency as compared with the liquid crystal display according to Comparative Example 1, and that the liquid crystal projectors according to Examples 8 to 14 have an equivalent contrast to that of the liquid crystal projector according to Comparative Example 2.

The optical compensatory elements of the present invention can optically compensate a liquid crystal layer under a condition for displaying black more precisely and prevent light leakage at a wide viewing angle. The resulting liquid crystal displays can be suitably used typically in mobile phones, monitors for personal computers, television sets and liquid crystal projectors.

1-21. (canceled)

22. An optical compensatory element comprising:
a support;
at least one first optically anisotropic layer derived from at least one of inorganic materials and arranged on or above at least one side of the support; and
at least one second optically anisotropic layer derived from at least one of polymerizable liquid crystal compounds and arranged on or above at least one side of the support.

23. The optical compensatory element according to claim 22, wherein both the first optically anisotropic layer and the second optically anisotropic layer are arranged on or above at least one side of the support.

24. The optical compensatory element according to claim 22,
wherein the first optically anisotropic layer is an alternately multilayered structure comprising a repeating unit, the repeating unit comprising plural layers having different refractive indices and being arranged in a regular order,
wherein the repeating unit has an optical thickness less than the wavelength of light in the visible region, and
wherein the optical compensatory element as a whole exhibits a negative anisotropy in refractive index.

25. The optical compensatory element according to claim 24,
wherein the repeating unit constituting the alternately multilayered structure comprises two different layers having different refractive indices, and
wherein the difference in refractive index in the visible region between the two layers is 0.5 or more.

26. The optical compensatory element according claim 24, wherein the repeating unit constituting the alternately multilayered structure comprises oxide layers.

27. The optical compensatory element according to claim 26, wherein the repeating unit constituting the alternately multilayered structure comprises a SiO₂ layer and a TiO₂ layer.

28. The optical compensatory element according to claim 22, wherein the first optically anisotropic layer has a retardation Rth represented by following Equation (1) of 20 nm to 500 nm:
Rth={(nₓ+n_{y})/2−n_{z}}×d Equation (1)
wherein nₓ, n_{y} and n_{z} are refractive indices in the X, Y and Z axes in the first optically anisotropic layer, respectively, where the X, Y and Z axes are orthogonal to one another, provided that the direction of the normal to the support is defined as the Z axis; and “d” is the thickness of the first optically anisotropic layer.

29. The optical compensatory element according to claim 22,
wherein the second optically anisotropic layer comprises a polymerizable liquid crystal compound having a liquid crystal structure, and
wherein the angle of alignment of the liquid crystal structure in the polymerizable liquid crystal compound is fixed, as a result of polymerization, as being oblique to a thickness direction of the second optically anisotropic layer.

30. The optical compensatory element according to claim 29, wherein the liquid crystal structure in the polymerizable liquid crystal compound is in a hybrid alignment in which the angle of alignment varies in a thickness direction of the second optically anisotropic layer.

31. The optical compensatory element according to claim 29, wherein the liquid crystal structure in the second optically anisotropic layer is aligned in a certain direction.

32. The optical compensatory element according to claim 29, wherein the second optically anisotropic layer comprises two layers having different direction of alignments.

33. The optical compensatory element according to claim 32, wherein the two layers having different direction of alignments and serving as the second optically anisotropic layer are arranged on or above one side of the support.

34. The optical compensatory element according to claim 32, wherein the two layers having different direction of alignments and serving as the second optically anisotropic layer are arranged so as to sandwich the support.

35. The optical compensatory element according to claim 32, wherein the second optically anisotropic layer comprises two layers having direction of alignments perpendicular to each other.

36. The optical compensatory element according to claim 29, wherein the polymerizable liquid crystal compound comprises a discotic liquid crystal structure.

37. The optical compensatory element according to claim 29, wherein the polymerizable liquid crystal compound comprises a rod-shaped liquid crystal structure.

38. The optical compensatory element according to claim 22, which is used for a liquid crystal projector.

39. A method for manufacturing an optical compensatory element, comprising
laminating plural layers in a regular order on or above a support, the plural layers each comprising at least one of inorganic materials and having different refractive indices; and
polymerizing a polymerizable liquid crystal compound having a liquid crystal structure while keeping the liquid crystal structure being aligned.

40. A liquid crystal display, comprising:
a liquid crystal device comprising at least one pair of electrodes and liquid crystal molecules encapsulated in between the at least one pair of electrodes;
an optical compensatory element arranged on or above at least one side of the liquid crystal device; and
at least one polarizing element facing the liquid crystal device and the optical compensatory element,
wherein the optical compensatory element is an optical compensatory element comprising:
a support;
at least one first optically anisotropic layer derived from at least one of inorganic materials and arranged on or above at least one side of the support; and
at least one second optically anisotropic layer derived from at least one of polymerizable liquid crystal compounds and arranged on or above at least one side of the support.

41. The liquid crystal display according to claim 40, wherein the liquid crystal device is a twisted nematic liquid crystal device.

42. A liquid crystal projector comprising:
a liquid crystal display;
a light source for applying light to the liquid crystal display; and
a projection optical system for forming an image on a screen from light optically modulated by the liquid crystal display,
wherein the liquid crystal display is a liquid crystal display according comprising:
a liquid crystal device comprising at least. one pair of electrodes and liquid crystal molecules encapsulated in between the at least one pair of electrodes;
an optical compensatory element arranged on or above at least one side of the liquid crystal device; and
at least one polarizing element facing the liquid crystal device and the optical compensatory element, and
wherein the optical compensatory element is an optical compensatory element comprising:
a support;
at least one first optically anisotropic layer derived from at least one of inorganic materials and arranged on or above at least one side of the support; and
at least one second optically anisotropic layer derived from at least one of polymerizable liquid crystal compounds and arranged on or above at least one side of the support.
